(19) United States
(12) Patent Application Publication
(10) Pub. No.: US 2025/0199388 A1
(43) Pub. Date: Jun. 19, 2025

(54) PROJECTOR

(71) Applicant: SEIKO EPSON CORPORATION, Tokyo (JP)

(72) Inventor: Koichi AKIYAMA, AZUMINO-SHI (JP)

(21) Appl. No.: 18/979,768

(22) Filed: Dec. 13, 2024

(30) Foreign Application Priority Data
Dec. 13, 2023 (JP) 2023-210235

(51) Int. Cl. G03B 21/20; G03B 21/00; G03B 21/16

(52) U.S. Cl. CPC G03B 21/208; G03B 21/006; G03B 21/16; G03B 21/2053; G03B 21/2073

(57) ABSTRACT

A projector includes a first light source configured to output linearly polarized first light; a first light collector configured to collect the first light output from the first light source; a first light guiding member configured to guide the first light output from the first light collector; and a first liquid crystal panel configured to modulate the first light output from the first light guiding member. The first light guiding member has a first light incident surface on which the first light output from the first light collector is incident, a first light exiting surface via which the first light exits toward the first liquid crystal panel, and a first inclining section inclining with respect to a first optical axis of the first light guiding member, a cross-sectional area of the first inclining section increasing as the first light guiding member extending in a direction in which the first light is guided. The first light exiting surface of the first light guiding member and a light-incident-side portion of the first liquid crystal panel are in contact with each other, or an air layer having a dimension of 3 μm or smaller is provided between the first light exiting surface and the light-incident-side portion of the first liquid crystal panel.

The present application is based on, and claims priority from JP Application Serial Number 2023-210235, filed Dec. 13, 2023, the disclosure of which is hereby incorporated by reference herein in its entirety.

### BACKGROUND

### 1. Technical Field

The present disclosure relates to a projector.

### 2. Related Art

There is a known projector including three liquid crystal panels as light modulators that generate three types of image light having three primary colors, that is, a three-plate projector. For example, JP-A-2010-276757 discloses a three-plate projector. The projector disclosed in JP-A-2010-276757 includes three sets of illumination systems each including a light source and a light guiding rod, and three sets of liquid crystal panels with microlens arrays disposed at the light incident side thereof. The light guiding rod is disposed so as to face the microlens array with a gap therebetween.

JP-A-2010-276757 is an example of the related art.

In the three-plate projector disclosed in JP-A-2010-276757, which has a configuration in which the liquid crystal panels are each uniformly illuminated by using a tapered rod, a space is created between the light guiding rod and the liquid crystal panel, and air is caused to flow through the space to cool the liquid crystal panel. The three-plate projector described above, however, has a problem of a decrease in light use efficiency because the space provided between each of the liquid crystal panels and the corresponding light guiding rod causes leakage of part of the illumination light via the space out of the illumination system.

### SUMMARY

A projector according to an aspect of the present disclosure includes a first light source configured to output linearly polarized first light; a first light collector configured to collect the first light output from the first light source; a first light guiding member configured to guide the first light output from the first light collector; and a first liquid crystal panel configured to modulate the first light output from the first light guiding member. The first light guiding member has a first light incident surface on which the first light output from the first light collector is incident, a first light exiting surface via which the first light exits toward the first liquid crystal panel, and a first inclining section inclining with respect to a first optical axis of the first light guiding member, a cross-sectional area of the first inclining section increasing as the first light guiding member extending in a direction in which the first light is guided. The first light exiting surface of the first light guiding member and a light-incident-side portion of the first liquid crystal panel are in contact with each other, or an air layer having a dimension of 3 μm or smaller is provided between the first light exiting surface and the light-incident-side portion of the first liquid crystal panel.

### BRIEF DESCRIPTION OF THE DRAWINGS

FIG. 1 is a schematic view of a projector according to a first embodiment.

FIG. 2 is a schematic view of a blue light emitter and a liquid crystal panel for blue light of the projector shown in FIG. 1.

FIG. 3 is a perspective view of a light guiding member of the blue light emitter of the projector shown in FIG. 1.

FIG. 4 is an image showing a result of numerical-simulation-based calculation of the illuminance distribution of blue light emitted from the blue light emitter of the projector shown in FIG. 1.

FIG. 5 is an image showing a result of the numerical-simulation-based calculation of the illuminance distribution of blue light emitted from a blue light emitter of a projector of related art.

FIG. 6 is a schematic view of a blue light emitter and a liquid crystal panel for blue light of a projector according to a second embodiment.

### DESCRIPTION OF EMBODIMENTS

Embodiments of the present disclosure will be described below with reference to the drawings. In the drawings, elements are drawn at different dimensional scales in some cases for clarity of each of the elements.

### First Embodiment

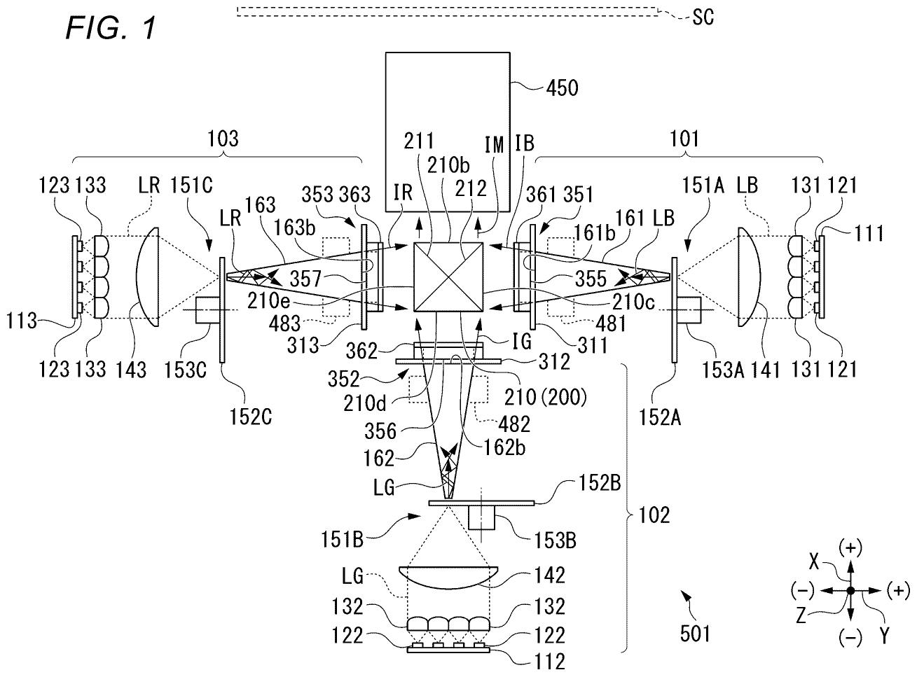

A first embodiment of the present disclosure will first be described with reference to FIGS. 1 to 5. FIG. 1 is a schematic view of a projector 501 according to the first embodiment of the present disclosure. The projector 501 is an image display apparatus including three liquid crystal panels as light modulators, and is what is called a three-plate projector. The projector 501 includes a blue light emitter 101, a green light emitter 102, a red light emitter 103, liquid crystal panels 351, 352, and 353, a light combining member 200, a projection system 450, and cooling fans 481, 482, and 483, as shown in FIG. 1.

The blue light emitter 101 emits blue light LB. In the following description, the direction of an axis parallel to the optical axis of the blue light LB emitted from the blue light emitter 101 is called a Y direction. One side in the Y direction is called a −Y side, and the side opposite the −Y side in the Y direction is called a +Y side. A direction perpendicular to the Y direction in a plane containing the optical axis of the blue light LB is called an X direction. One side in the X direction is called a −X side, and the side opposite the −X side in the X direction is called a +X side. The direction perpendicular to the X and Y directions is called a Z direction. The Z direction corresponds to a height direction. The blue light LB on the blue light emitter 101 travels from the +Y side toward the −Y side along the Y direction.

The blue light emitter 101 includes light sources 121, parallelizing elements 131, a light collector 141, a diffuser 151A, and a light guiding member 161. The blue light emitter 101 includes, for example, four light sources 121 in the X direction. The number of the light sources 121 provided in the blue light emitter 101 is set as appropriate in accordance with the ratio of the required amount of the blue light LB emitted from the blue light emitter 101 toward the light combining member 200 to the amount of the blue light LB output from one of the light sources 121.

The light sources 121 are supported by a substrate 111. The light sources 121 are provided at the −Y-side plate surface out of the plate surfaces of the substrate 111 that are parallel to the XZ plane containing the X and Z directions, and are arranged at intervals, for example, in the X direction. The substrate 111 is made, for example, of metal or alloy, and may instead be configured with an insulator made, for example, of resin. Metal wires and electrodes none of which are shown are disposed on the −Y-side plate surface of the substrate 111. The metal wires and electrodes provided at the substrate 111 are coupled to the light sources 121.

The light emission surface of each of the light sources 121 is disposed substantially in parallel to the XZ plane, and is the surface of the light source 121 that is opposite in the Y direction the surface thereof in contact with the −Y-side plate surface of the substrate 111. The light sources 121 correspond to a first light source, and each output the blue light LB, which belongs to a blue wavelength band in a visible wavelength band and is linearly polarized light. The blue light LB corresponds to first light. The polarization direction of the blue light LB is along any one direction, and is, for example, parallel to the X or Z direction. The blue light LB is, for example, P-polarized light. The blue light LB exits via the light emission surface of each of the light sources 121, diverges at an angle according to the size of the light emission surface, the peak wavelength of the blue light LB, and other factors around an axis passing through the center of the light emission surface of the light source 121 and parallel to the Y direction, and travels toward the −Y side. The blue wavelength band is, for example, a wavelength band ranging from 420 nm to 500 nm.

The light sources 121 are each configured, for example, with a laser diode (LD) that emits the blue light LB. When the blue light emitter 101 includes multiple light sources 121, two or more light sources 121 may be arranged on the −Y-side plate surface of the substrate 111 at intervals in the Z direction in addition to the X direction, or may be arranged at intervals only in the Z direction.

The blue light emitter 101 includes the parallelizing elements 131, the number of which is equal to the number of the light sources 121. Each of the multiple parallelizing elements 131 is disposed in correspondence with one of the multiple light sources 121. The parallelizing elements 131 are arranged in the optical path of the blue light LB output from the light sources 121 arranged in one-to-one correspondence with the parallelizing elements 131. The parallelizing elements 131 are disposed at positions where the parallelizing elements 131 coincide with the light sources 121 in the X and Z directions, and are shifted from the light sources 121 toward the −Y side. The light incident surfaces of the parallelizing elements 131 face the light exiting surfaces of the light sources 121. The parallelizing elements 131 each parallelize the blue light LB output from the corresponding light source 121 and radially diverging around the optical axis parallel to the Y direction, and output the parallelized blue light LB toward the −Y side along the Y direction.

The light collector 141 is disposed at a position where the light collector 141 overlaps with the region occupied by the parallelizing elements 131, the number of which is equal to the number of the light sources 121, in the X and Z directions and is shifted from the parallelizing elements 131 toward the −Y side. The light collector 141 corresponds to a first light collector. The light collector 141 collects the multiple luminous fluxes of the blue light LB output from the parallelizing elements 131 along the Y direction, outputs the collected luminous flux toward the −Y side along the Y direction, and collects the luminous flux at a position on the optical axis in the XZ plane. The light collector 141 is, for example, a plano-convex lens having a curved convex surface facing the side on which the blue light LB is incident, and may instead be an optical element other than a plano-convex lens, such as a biconvex lens capable of collecting the incident blue light LB as described above.

The diffuser 151A includes a diffuser substrate 152A and a driver 153A. The diffuser substrate 152A has a diffusing surface extending along the XZ plane, is formed in a circular shape when viewed along the Y direction, and has an appropriate thickness in the Y direction. The center of the diffuser substrate 152A in the XZ plane is shifted from the optical axis of the blue light LB output from the light collector 141, for example, disposed at a position shifted from the optical axis of the blue light LB toward the −X side and located at a position that substantially coincides with the optical axis of the blue light LB in the Z direction. The optical axis of the blue light LB output from the light collector 141 intersects with the diffuser substrate 152A at a position between a predetermined position, which is shifted outward from the center of the diffuser substrate 152A in the XZ plane in the radial direction with respect to the center, and the outer circumferential end of the diffuser substrate 152A. The predetermined position described above corresponds to the position where the predetermined position coincides with the outer edge of the driver 153A in the radial direction with reference to the center of the diffuser substrate 152A in the XZ plane when viewed along the Y direction.

A minute uneven structure designed in accordance with the peak wavelength and other factors of the incident color light is formed at the diffusing surface of the diffuser 151A. The uneven structure may be configured, for example, with a microlens array including multiple microlenses, or may be formed by blasting. The unevenness does not necessarily have a specific shape and may have any shape capable of diffusing the incident blue light LB in the XZ plane.

The driver 153A is disposed at a position shifted toward the −X side from the optical path of the blue light LB output from the light collector 141, also shifted toward the +Y side from the diffuser substrate 152A, and is disposed within the range where the driver 153A overlaps with the optical path of the blue light LB in the Z direction. The driver 153A is coupled to the diffuser substrate 152A coaxially with the axis of rotation passing through the center of the diffuser substrate 152A in the XZ plane. The driver 153A rotates the diffuser substrate 152A at a desired rotational speed in the circumferential direction around the axis of rotation of the diffuser substrate 152A. The blue light LB incident on the diffuser substrate 152A from the +Y side is collected in the vicinity of the diffusing surface of the diffuser substrate 152A in the Y direction, passes through the diffuser substrate 152A along the Y direction, and is diffused in the XZ plane. The diffused blue light LB exits from the diffuser substrate 152A toward the −Y side and diverges in the XZ plane.

The light guiding member 161 is disposed in the optical path of the blue light LB output from the diffuser substrate 152A of the diffuser 151A, and is shifted toward the −Y side from the diffuser substrate 152A. The light guiding member 161 is formed in a shape elongated along the Y direction. The center axis of the light guiding member 161 in the XZ plane is parallel to the Y direction and coincides with the optical axis of the blue light LB output from the diffuser 151A. The light guiding member 161 corresponds to a first light guiding member. The light guiding member 161 guides the blue light LB output from the light collector 141 and diffused by the diffuser 151A toward the −Y side, and causes the blue light LB to be incident on the liquid crystal panel 351 for blue light via a dustproof glass plate 311. The configuration of the light guiding member 161 will be described later in detail.

The polarization direction of the blue light LB is maintained in the optical path of the blue light LB over the range from the light emission surfaces of the light sources 121 in the blue light emitter 101 to the −Y-side end surface of the light guiding member 161, that is, a light exiting surface 161b, which will be described later. Specifically, the polarization direction of the blue light LB output from each of the light sources 121 is parallel to the X direction, that is, the direction parallel to the long sides of an image formation region 355, which will be described later, of the liquid crystal panel 351, or the Z direction, that is, the direction parallel to the short sides of the image formation region 355 of the liquid crystal panel 351. In the optical path of the blue light LB, the parallelizing elements 131, the light collector 141, the diffuser substrate 152A of the diffuser 151A, and the light guiding member 161, which are disposed downstream from the light sources 121, are each, for example, a polarization preserving element or member. The parallelizing elements 131, the light collector 141, the diffuser substrate 152A, and the light guiding member 161 may each be made, for example, of quartz, which is a material having an excellent polarization preservation property. In particular, the fact that the light guiding member 161, which occupies a certain length of the optical path of the blue light LB emitted from the blue light emitter 101, is made of quartz is effective in the preservation of the polarization direction of the blue light LB.

The liquid crystal panel 351 is provided in the optical path of the blue light LB output from the light guiding member 161, disposed at a position where the liquid crystal panel 351 overlaps with the light exiting surface 161b of the light guiding member 161 in the X and Z directions, and shifted from the light guiding member 161 toward the −Y side. The liquid crystal panel 351 corresponds to a first liquid crystal panel, and modulates the blue light LB output from the light guiding member 161 and passing through the dustproof glass plate 311 based on image information transmitted from an image forming apparatus such as a computer that is not shown but is externally coupled to the liquid crystal panel 351 to generate blue image light IB.

The liquid crystal panel 351 is, for example, a transmissive liquid crystal panel. The liquid crystal panel 351 has the image formation region 355, where multiple pixels that are not shown are arranged along the X and Z directions in the XZ plane. The pixels each include a switching element. The switching element is, for example, a polysilicon thin film transistor (TFT). An electric signal according to the brightness of the blue light at the relative position of each of the pixels of the liquid crystal panel 351 in an image projected by the projector 501 is supplied to the switching element in the pixel. The pixels of the liquid crystal panel 351 modulate the vibration direction of the blue light LB incident from the light guiding member 161 via the dustproof glass plate 311 with the aid of the operation of the switching elements according to the electric signal described above to generate the image light IB. The liquid crystal panel 351 outputs the image light IB toward the −Y side along the Y direction.

The dustproof glass plate 311 has plate surfaces parallel to the XZ plane, and is disposed at a position where the dustproof glass plate 311 overlaps with the light guiding member 161 in the X and Z directions, and which is closest to the +Y side in the liquid crystal panel 351. The +Y-side plate surface of the dustproof glass plate 311 is in contact with the −Y-side end surface of the light guiding member 161, that is, the light exiting surface 161b. The dustproof glass plate 311 prevents substances such as dust that block propagation of the blue light LB to the light combining member 200 from entering a pixel constituting portion of the liquid crystal panel 351 from the +Y side. The pixel constituting portion of the liquid crystal panel 351 will be described later. The dustproof glass plate 311 is made of a material that transmits light that belongs to at least the blue wavelength band out of the visible wavelength band, and is preferably made of a material that excels in heat dissipation. The dustproof glass plate 311 is preferably made, for example, of sapphire, which is a material that excels in light transparency and heat dissipation, and may instead be made of quartz, optical glass, or the like.

A light-exiting-side polarizer plate 361 is provided in the optical path of the image light IB output from the liquid crystal panel 351, and disposed at a position where the light-exiting-side polarizer plate 361 coincides with the liquid crystal panel 351 in the X and Z directions, and which is closest to the −Y side in the liquid crystal panel 351. The light-exiting-side polarizer plate 361 has plate surfaces parallel to the XZ plane. The +Y-side plate surface of the light-exiting-side polarizer plate 361 is in contact, for example, with the −Y-side plate surface of the liquid crystal panel 351 that is parallel to the XZ plane, that is, the light exiting surface thereof via which the image light IB exits toward the −Y side. The light-exiting-side polarizer plate 361 outputs a predetermined polarized component of the image light IB output from the liquid crystal panel 351 toward the −Y side along the Y direction, and blocks the components other than the predetermined polarized component of the image light IB. The predetermined polarized light is, for example, P polarized light. That is, the predetermined polarized light is linearly polarized light polarized in the Y or X direction. The light-exiting-side polarizer plate 361 is, for example, an absorptive or reflective polarizer plate having a transmission axis for the predetermined polarized light. When it is desired to suppress return light and stray light that return to the liquid crystal panel 351, an absorptive polarizer plate is preferably used as the light-exiting-side polarizer plate 361.

The green light emitter 102 is disposed at a position shifted from the blue light emitter 101 toward the −X side and the −Y side and disposed in a region where the green light emitter 102 overlaps with the blue light emitter 101 in the Z direction. The green light emitter 102 emits green light LG. The green light LG in the green light emitter 102 travels from the −X side toward the +X along the X direction.

The green light emitter 102 includes light sources 122, parallelizing elements 132, a light collector 142, a diffuser 151B, and a light guiding member 162. The green light emitter 102 includes, for example, four light sources 122 in the Y direction. The number of the light sources 122 provided in the green light emitter 102 is set as appropriate in accordance with the ratio of the required amount of the green light LG emitted from the green light emitter 102 toward the light combining member 200 to the amount of the green light LG output from one of the light sources 122.

The light sources 122 are supported by a substrate 112. The light sources 122 are provided at the +X-side plate surface out of the plate surfaces of the substrate 112 that are parallel to the YZ plane containing the Y and Z directions, and are arranged at intervals, for example, in the Y direction. The substrate 112 is made, for example, of metal or alloy, and may instead be configured with an insulator made, for example, of resin, as the substrate 111. Metal wires and electrodes none of which are shown are disposed on the +X-side plate surface of the substrate 112. The metal wires and electrodes provided at the substrate 112 are coupled to the light sources 122.

The light emission surface of each of the light sources 122 is disposed substantially in parallel to the YZ plane, and is the surface of the light source 122 that is opposite in the X direction the surface thereof in contact with the +X-side plate surface of the substrate 112. The light sources 122 correspond to a second light source, and each output the green light LG, which belongs to a green wavelength band in the visible wavelength band and is linearly polarized light. The green light LG corresponds to second light. The polarization direction of the green light LG is along any one direction, and is, for example, parallel to the Y or Z direction. The green light LG is, for example, P-polarized light. The green light LG is output via the light emission surface of each of the light sources 122, diverges at an angle according to the size of the light emission surface, the peak wavelength of the green light LG, and other factors around an axis passing through the center of the light emission surface of the light source 122 and parallel to the X direction, and travels toward the +X side. The green wavelength band is, for example, a wavelength band ranging from 520 nm to 620 nm.

The light sources 122 are each configured, for example, with an LD that emits the green light LG. When the green light emitter 102 includes multiple light sources 122, two or more light sources 122 may be arranged on the +X-side plate surface of the substrate 112 at intervals in the Z direction in addition to the Y direction, or may be arranged at intervals only in the Z direction.

The green light emitter 102 includes the parallelizing elements 132, the number of which is equal to the number of the light sources 122. Each of the multiple parallelizing elements 132 is disposed in correspondence with one of the multiple light sources 122. The parallelizing elements 132 are arranged in the optical path of the green light LG output from the light sources 122 arranged in one-to-one correspondence with the parallelizing elements 132. The parallelizing elements 132 are disposed at positions where the parallelizing elements 132 coincide with the light sources 122 in the Y and Z directions, and are shifted from the light sources 122 toward the +X side. The light incident surfaces of the parallelizing elements 132 face the light exiting surfaces of the light sources 122. The parallelizing elements 132 each parallelize the green light LG output from the corresponding light source 122 and radially diverging around the optical axis parallel to the X direction, and output the parallelized green light LG toward the +X side along the X direction.

The light collector 142 is disposed at a position where the light collector 142 overlaps with the region occupied by the parallelizing elements 132, the number of which is equal to the number of the light sources 122, in the Y and Z directions and is shifted from the parallelizing elements 132 toward the +X side. The light collector 142 corresponds to a second light collector. The light collector 142 collects the multiple luminous fluxes of the green light LG output from the parallelizing elements 132 along the X direction, outputs the collected luminous flux toward the +X side along the X direction, and collects the luminous flux at a position on the optical axis in the YZ plane. The light collector 142 is, for example, a plano-convex lens having a curved convex surface facing the side on which the green light LG is incident, and may instead be an optical element other than a plano-convex lens, such as a biconvex lens capable of collecting the incident green light LG as described above.

The diffuser 151B includes a diffuser substrate 152B and a driver 153B. The diffuser substrate 152B has a diffusing surface extending along the YZ plane, is formed in a circular shape when viewed along the X direction, and has an appropriate thickness in the X direction. The center of the diffuser substrate 152B in the YZ plane is shifted from the optical axis of the green light LG output from the light collector 142, for example, disposed at a position shifted from the optical axis of the green light LG toward the +Y side and located at a position that substantially coincides with the optical axis of the green light LG in the Z direction. The optical axis of the green light LG output from the light collector 142 intersects with the diffuser substrate 152B at a position between a predetermined position, which is shifted outward from the center of the diffuser substrate 152B in the YZ plane in the radial direction with respect to the center, and the outer circumferential end of the diffuser substrate 152B. The predetermined position described above corresponds to the position where the predetermined position coincides with the outer edge of the driver 153B in the radial direction with reference to the center of the diffuser substrate 152B in the YZ plane when viewed along the X direction.

The driver 153B is disposed at a position shifted toward the +Y side from the optical path of the green light LG output from the light collector 142, also shifted toward the −X side from the diffuser substrate 152B, and is disposed within the range where the driver 153B overlaps with the optical path of the green light LG in the Z direction. The driver 153B is coupled to the diffuser substrate 152B coaxially with the axis of rotation passing through the center of the diffuser substrate 152B in the YZ plane. The green light LG incident on the diffuser substrate 152B from the −X side is collected in the vicinity of the diffusing surface of the diffuser substrate 152B in the X direction, passes through the diffuser substrate 152B along the X direction, and is diffused in the YZ plane. The diffused green light LG exits from the diffuser substrate 152B toward the +X side and diverges in the YZ plane. A minute uneven structure is formed at the diffusing surface of the diffuser substrate 152B, as in the case of the diffusing surface of the diffuser substrate 152A.

The light guiding member 162 is disposed in the optical path of the green light LG output from the diffuser substrate 152B of the diffuser 151B, and is shifted toward the +X side from the diffuser substrate 152B. The light guiding member 162 is formed in a shape elongated along the X direction. The center axis of the light guiding member 162 in the YZ plane is parallel to the X direction and coincides with the optical axis of the green light LG output from the diffuser 151B. The light guiding member 162 corresponds to a second light guiding member. The light guiding member 162 guides the green light LG output from the light collector 142 and diffused by the diffuser 151B toward the +X side, and causes the green light LG to be incident on the liquid crystal panel 352 for green light via a dustproof glass plate 312.

The polarization direction of the green light LG is maintained in the optical path of the green light LG over the range from the light emission surfaces of the light sources 122 in the green light emitter 102 to the +X-side end surface of the light guiding member 162, that is, a light exiting surface 162b. Specifically, the polarization direction of the green light LG output from each of the light sources 122 is parallel to the Y direction, that is, the direction parallel to the long sides of an image formation region 356, which will be described later, of the liquid crystal panel 352, or the Z direction, that is, the direction parallel to the short sides of the image formation region 356 of the liquid crystal panel 352. In the optical path of the green light LG, the parallelizing elements 132, the light collector 142, the diffuser substrate 152B of the diffuser 151B, and the light guiding member 162, which are disposed downstream from the light sources 122, are each, for example, a polarization preserving element or member. The parallelizing elements 132, the light collector 142, the diffuser substrate 152B, and the light guiding member 162 may each be made, for example, of quartz, which is a material having an excellent polarization preservation property. In particular, the fact that the light guiding member 162, which occupies a certain length of the optical path of the green light LG emitted from the green light emitter 102, is made of quartz is effective in preservation of the polarization direction of the green light LG.

The liquid crystal panel 352 is provided in the optical path of the green light LG output from the light guiding member 162, disposed at a position where the liquid crystal panel 352 overlaps with the light exiting surface 162b of the light guiding member 162 in the Y and Z directions, and shifted from the light guiding member 162 toward the +X side. The liquid crystal panel 352 corresponds to a second liquid crystal panel, and modulates the green light LG output from the light guiding member 162 and passing through the dustproof glass plate 312 based on image information transmitted from the image forming apparatus such as a computer, which is not shown but is externally coupled to the liquid crystal panel 352, to generate green image light IG.

The liquid crystal panel 352 is, for example, a transmissive liquid crystal panel. The liquid crystal panel 352 has the image formation region 356, where multiple pixels that are not shown are arranged along the Y and Z directions in the YZ plane. The pixels each include a switching element such as a TFT. An electric signal according to the brightness of the green light at the relative position of each of the pixels of the liquid crystal panel 352 in an image projected by the projector 501 is supplied to the switching element in the pixel. The pixels of the liquid crystal panel 352 modulate the vibration direction of the green light LG incident from the light guiding member 162 via the dustproof glass plate 312 with the aid of the operation of the switching elements according to the electric signal described above to generate the image light IG. The liquid crystal panel 352 outputs the image light IG toward the +X side along the X direction.

The dustproof glass plate 312 has plate surfaces parallel to the YZ plane, and is disposed at a position where the dustproof glass plate 312 overlaps with the light guiding member 162 in the Y and Z directions, and which is closest to the −X side in the liquid crystal panel 352. The −X-side plate surface of the dustproof glass plate 312 is in contact with the +X-side end surface of the light guiding member 162, that is, the light exiting surface 162b. The dustproof glass plate 312 prevents substances such as dust that block propagation of the green light LG to the light combining member 200 from entering the liquid crystal panel 352. The dustproof glass plate 312 is made of a material that transmits light that belongs to at least the green wavelength band out of the visible wavelength band, and is preferably made of a material that excels in heat dissipation. The dustproof glass plate 312 is preferably made, for example, of sapphire, which is a material that excels in light transparency and heat dissipation, and may instead be made of quartz, optical glass, or the like.

A light-exiting-side polarizer plate 362 is provided in the optical path of the image light IG output from the liquid crystal panel 352, and disposed at a position where the light-exiting-side polarizer plate 362 coincides with the liquid crystal panel 352 in the Y and Z directions, and which is closest to the +X side in the liquid crystal panel 352. The light-exiting-side polarizer plate 362 has plate surfaces parallel to the YZ plane. The −X-side plate surface of the light-exiting-side polarizer plate 362 is in contact, for example, with the +X-side plate surface of the liquid crystal panel 352 that is parallel to the YZ plane, that is, the light exiting surface thereof via which the image light IG exits toward the +X side. The light-exiting-side polarizer plate 362 outputs a predetermined polarized component of the image light IG output from the liquid crystal panel 352 toward the +X side along the X direction, and blocks the components other than the predetermined polarized component of the image light IG. The predetermined polarized light is, for example, P polarized light. The light-exiting-side polarizer plate 362 is, for example, an absorptive or reflective polarizer plate having a transmission axis for the predetermined polarized light. When it is desired to suppress return light and stray light that return to the liquid crystal panel 352, an absorptive polarizer plate is preferably used as the light-exiting-side polarizer plate 362.

The red light emitter 103 is disposed in a region where the red light emitter 103 overlaps with the blue light emitter 101 in the X and Z directions, and is shifted from the green light emitter 102 toward the +X side. The red light emitter 103 emits red light LR. The red light LR in the red light emitter 103 travels from the −Y side toward the +Y along the Y direction.

The red light emitter 103 includes light sources 123, parallelizing elements 133, a light collector 143, a diffuser 151C, and a light guiding member 163. The red light emitter 103 includes, for example, four light sources 123 in the X direction. The number of the light sources 123 provided in the red light emitter 103 is set as appropriate in accordance with the ratio of the required amount of the red light LR emitted from the red light emitter 103 toward the light combining member 200 to the amount of the red light LR emitted from one of the light sources 123.

The light sources 123 are supported by a substrate 113. The light sources 123 are provided at the +Y-side plate surface out of the plate surfaces of the substrate 113 that are parallel to the XZ plane, and are arranged at intervals, for example, in the Y direction. The substrate 113 is made, for example, of metal or alloy, and may instead be configured with an insulator made, for example, of resin, as the substrates 111 and 112. Metal wires and electrodes none of which are shown are disposed on the +Y-side plate surface of the substrate 113. The metal wires and electrodes provided at the substrate 113 are coupled to the light sources 123.

The light emission surface of each of the light sources 123 is disposed substantially in parallel to the XZ plane, and is the surface of the light source 123 that is opposite in the Y direction the surface thereof in contact with the +Y-side plate surface of the substrate 113. The light sources 123 correspond to a third light source, and each output the red light LR, which belongs to a red wavelength band in the visible wavelength band and is linearly polarized light. The red light LR corresponds to third light. The polarization direction of the red light LR is parallel to the X or Z direction. The red light LR is, for example, P-polarized light. The red light LR exits via the light emission surface of each of the light sources 123, diverges at an angle according to the size of the light emission surface, the peak wavelength of the red light LR, and other factors around an axis passing through the center of the light emission surface of the light source 123 and parallel to the Y direction, and travels toward the +Y side. The red wavelength band is, for example, a wavelength band ranging from 600 nm to 680 nm.

The light sources 123 are each configured, for example, with an LD that emits the red light LR. When the red light emitter 103 includes multiple light sources 123, two or more light sources 123 may be arranged on the +Y-side plate surface of the substrate 113 at intervals in the Z direction in addition to the X direction, or may be arranged at intervals only in the Z direction.

The red light emitter 103 includes the parallelizing elements 133, the number of which is equal to the number of the light sources 123. Each of the multiple parallelizing elements 133 is disposed in correspondence with one of the multiple light sources 123. The parallelizing elements 133 are arranged in the optical path of the red light LR output from the light sources 123 arranged in one-to-one correspondence with the parallelizing elements 133. The parallelizing elements 133 are disposed at positions where the parallelizing elements 133 coincide with the light sources 123 in the X and Z directions, and are shifted from the light sources 123 toward the +Y side. The light incident surfaces of the parallelizing elements 133 face the light exiting surfaces of the light sources 123. The parallelizing elements 133 each parallelize the red light LR output from the corresponding light source 123 and radially diverging around the optical axis parallel to the Y direction, and output the parallelized red light LR toward the +Y side along the Y direction.

The light collector 143 is disposed at a position where the light collector 143 overlaps with the region occupied by the parallelizing elements 133, the number of which is equal to the number of the light sources 123, in the X and Z directions and is shifted from the parallelizing elements 133 toward the +Y side. The light collector 143 corresponds to a third light collector. The light collector 143 collects the multiple luminous fluxes of the red light LR output from the parallelizing elements 133 along the Y direction, output the collected luminous flux toward the +Y side along the Y direction, and collects the luminous flux at a position on the optical axis in the XZ plane. The light collector 143 is, for example, a plano-convex lens having a curved convex surface facing the side on which the red light LR is incident, and may instead be an optical element other than a plano-convex lens, such as a biconvex lens capable of collecting the incident red light LR as described above.

The diffuser 151C includes a diffuser substrate 152C and a driver 153C. The diffuser substrate 152C has a diffusing surface extending along the XZ plane, is formed in a circular shape when viewed along the Y direction, and has an appropriate thickness in the Y direction. The center of the diffuser substrate 152C in the XZ plane is shifted from the optical axis of the red light LR output from the light collector 143, for example, disposed at a position shifted from the optical axis of the red light LR toward the −X side and located at a position that substantially coincides with the optical axis of the red light LR in the Z direction. The optical axis of the red light LR output from the light collector 143 intersects with the diffuser substrate 152C at a position between a predetermined position, which is shifted outward from the center of the diffuser substrate 152C in the XZ plane in the radial direction with respect to the center, and the outer circumferential end of the diffuser substrate 152C. The predetermined position described above corresponds to the position where the predetermined position coincides with the outer edge of the driver 153C in the radial direction with reference to the center of the diffuser substrate 152C in the XZ plane when viewed along the Y direction.

The driver 153C is disposed at a position shifted toward the −X side from the optical path of the red light LR output from the light collector 143, also shifted toward the −Y side from the diffuser substrate 152C, and is disposed within the range where the driver 153C overlaps with the optical path of the red light LR in the Z direction. The driver 153C is coupled to the diffuser substrate 152C coaxially with the axis of rotation passing through the center of the diffuser substrate 152C in the XZ plane. The red light LR incident on the diffuser substrate 152C from the −Y side is collected in the vicinity of the diffusing surface of the diffuser substrate 152C in the Y direction, passes through the diffuser substrate 152C along the Y direction, and is diffused in the XZ plane. The diffused red light LR exits from the diffuser substrate 152C toward the +Y side and diverges in the XZ plane. A minute uneven structure is formed at the diffusing surface of the diffuser substrate 152C, as in the case of the diffusing surface of the diffuser substrate 152A.

The light guiding member 163 is disposed in the optical path of the red light LR output from the diffuser substrate 152C of the diffuser 151C, and is shifted toward the +Y side from the diffuser substrate 152C. The light guiding member 163 is formed in a shape elongated along the Y direction. The center axis of the light guiding member 163 in the XZ plane is parallel to the Y direction and coincides with the optical axis of the red light LR output from the diffuser 151C. The light guiding member 163 corresponds to a third light guiding member. The light guiding member 163 guides the red light LR output from the light collector 143 and diffused by the diffuser 151C toward the +Y side, and causes the red light LR to be incident on the liquid crystal panel 353 for red light via a dustproof glass plate 313.

The polarization direction of the red light LR is maintained in the optical path of the red light LR over the range from the light emission surfaces of the light sources 123 in the red light emitter 103 to the +Y-side end surface of the light guiding member 163, that is, a light exiting surface 163b. Specifically, the polarization direction of the red light LR output from each of the light sources 123 is parallel to the X direction, that is, the direction parallel to the long sides of an image formation region 357, which will be described later, of the liquid crystal panel 353, or the Z direction, that is, the direction parallel to the short sides of the image formation region 357 of the liquid crystal panel 353. In the optical path of the red light LR, the parallelizing elements 133, the light collector 143, the diffuser substrate 152C of the diffuser 151C, and the light guiding member 163, which are disposed downstream from the light sources 123, are each, for example, a polarization preserving element or member. The parallelizing elements 133, the light collector 143, the diffuser substrate 152C, and the light guiding member 163 may each be made, for example, of quartz, which is a material having an excellent polarization preservation property. In particular, the fact that the light guiding member 163, which occupies a certain length of the optical path of the red light LR emitted from the red light emitter 103, is made of quartz is effective in preservation of the polarization direction of the red light LR.

The liquid crystal panel 353 is provided in the optical path of the red light LR output from the light guiding member 163, disposed at a position where the liquid crystal panel 353 overlaps with the light exiting surface 163b of the light guiding member 163 in the X and Z directions, and shifted from the light guiding member 163 toward the +Y side. The liquid crystal panel 353 corresponds to a third liquid crystal panel, and modulates the red light LR output from the light guiding member 163 and passing through the dustproof glass plate 313 based on image information transmitted from the image forming apparatus such as a computer, which is not shown but is externally coupled to the liquid crystal panel 353 to generate red image light IR.

The liquid crystal panel 353 is, for example, a transmissive liquid crystal panel. The liquid crystal panel 353 has the image formation region 357, where multiple pixels that are not shown but are arranged along the X and Z directions in the XZ plane. The pixels each include a switching element such as a TFT. An electric signal according to the brightness of the red light at the relative position of each of the pixels of the liquid crystal panel 353 in an image projected by the projector 501 is supplied to the switching element in the pixel. The pixels of the liquid crystal panel 353 modulate the vibration direction of the red light LR incident from the light guiding member 163 via the dustproof glass plate 313 with the aid of the operation of the switching elements according to the electric signal described above to generate the image light IR. The liquid crystal panel 353 outputs the image light IR toward the +Y side along the Y direction.

The dustproof glass plate 313 has plate surfaces parallel to the XZ plane, is disposed at a position where the dustproof glass plate 313 overlaps with the light guiding member 163 in the X and Z directions, and which is closest to the −Y side in the liquid crystal panel 353. The −Y-side plate surface of the dustproof glass plate 313 is in contact with the +Y-side end surface of the light guiding member 163, that is, the light exiting surface 163b. The dustproof glass plate 313 prevents substances such as dust that block propagation of the red light LR to the light combining member 200 from entering the liquid crystal panel 353. The dustproof glass plate 313 is made of a material that transmits light that belongs to at least a red wavelength band out of the visible wavelength band, and is preferably made of a material that excels in heat dissipation. The dustproof glass plate 313 is preferably made, for example, of sapphire, which is a material that excels in light transparency and heat dissipation, and may instead be made of quartz, optical glass, or the like.

A light-exiting-side polarizer plate 363 is provided in the optical path of the image light IR output from the liquid crystal panel 353, and disposed at a position where the light-exiting-side polarizer plate 363 coincides with the liquid crystal panel 353 in the X and Z directions, and which is closest to the +Y side in the liquid crystal panel 353. The light-exiting-side polarizer plate 363 has plate surfaces parallel to the XZ plane. The −Y-side plate surface of the light-exiting-side polarizer plate 363 is in contact, for example, with the +Y-side plate surface of the liquid crystal panel 353 that is parallel to the XZ plane, that is, the light exiting surface thereof via which the image light IR exits toward the +Y side. The light-exiting-side polarizer plate 363 outputs a predetermined polarized component of the image light IR output from the liquid crystal panel 353 toward the +Y side along the Y direction, and blocks the components other than the predetermined polarized component of the image light IR. The predetermined polarized light is, for example, P polarized light. The light-exiting-side polarizer plate 363 is, for example, an absorptive or reflective polarizer plate having a transmission axis for the predetermined polarized light. When it is desired to suppress return light and stray light that return to the liquid crystal panel 353, an absorptive polarizer plate is preferably used as the light-exiting-side polarizer plate 363.

The light combining member 200 is disposed in a region where the optical path of the blue image light IB output from the light-exiting-side polarizer plate 361, the optical path of the green image light IG output from the light-exiting-side polarizer plate 362, and the optical path of the red image light IR output from the light-exiting-side polarizer plate 363 intersect with one another. The light combining member 200 combines the image light IB, the image light IG, and the image light IR with one another and outputs generated image light IM toward the +X side along the X direction.

The light combining member 200 is, for example, a cross dichroic prism 210. The cross dichroic prism 210 has a light incident surface 210c facing the light exiting surface of the light-exiting-side polarizer plate 361, a light incident surface 210d facing the light exiting surface of the light-exiting-side polarizer plate 362, a light incident surface 210e facing the light exiting surface of the light-exiting-side polarizer plate 363, a light exiting surface 210b, and two reflection films 211 and 212. The light incident surfaces 210c and 210e are parallel to the XZ plane and coincide with each other in the X and Z directions. The light incident surface 210e is located at a position shifted from the light incident surface 210c toward the −Y side. The light incident surface 210d and the light exiting surface 210b are parallel to the YZ plane and coincide with each other in the Y and Z directions. The light exiting surface 210b is located at a position shifted from the light incident surface 210d toward the +X side and shifted from the light incident surfaces 210c and 210e toward the +X side.

The reflection film 211 is disposed so as to extend from the +X side toward the −X side as extending from the −Y side toward the +Y side when viewed along the Z direction. The reflection film 212 is disposed so as to extend from the −X side toward the +X side as extending from the −Y side toward the +Y side when viewed along the Z direction. The reflection films 211 and 212 coincide with the light incident surfaces 210c and 210e in the X direction, coincide with the light incident surface 210d and the light exiting surface 210b in the Y direction, and overlap with the light incident surfaces 210c, 210d, and 210e and the light exiting surface 210b in the Z direction. The reflection film 211 reflects light that belongs to the blue wavelength band and transmits light that belongs to the green wavelength band and the red wavelength band. The reflection film 212 reflects light that belongs to the red wavelength band and transmits light that belongs to the blue wavelength band and the green wavelength band.

The cross dichroic prism 210 is made of a transparent material that transmits light that belongs to the visible wavelength band. The reflection films 211 and 212 are each configured, for example, with a dielectric multilayer film.

The predetermined polarized light out of the image light IB output from the light-exiting-side polarizer plate 361 travels toward the −Y side along the Y direction, enters the cross dichroic prism 210 via the light incident surface 210c, passes through the reflection film 212, is reflected off the reflection film 211, is deflected in the X direction, and travels toward the +X side. The predetermined polarized light out of the image light IG output from the light-exiting-side polarizer plate 362 travels toward the +X side along the X direction, enters the cross dichroic prism 210 via the light incident surface 210d, passes through the reflection films 211 and 212, and travels toward the +X side. The predetermined polarized light out of the image light IR output from the light-exiting-side polarizer plate 363 travels toward the +Y side along the Y direction, enters the cross dichroic prism 210 via the light incident surface 210e, passes through the reflection film 211, is reflected off the reflection film 212, is deflected in the X direction, and travels toward the +X side.

The image light IB, the image light IG, and the image light IR output from the reflection films 211 and 212 of the cross dichroic prism 210 toward the +X side are combined with one another to generate the full-color image light IM. The cross dichroic prism 210 outputs the image light IM via the light exiting surface 210b toward the +X side along the X direction.

The projection system 450 is disposed in the optical path of the image light IM output from the light combining member 200. The projection system 450 projects the image light IM onto a screen SC disposed at a position shifted from the projection system 450 toward the +X side, enlarges images transmitted from the image forming apparatus, which is not shown, to the liquid crystal panels 351, 352, and 353, and displays the enlarged images on the screen SC. The projection system 450 is configured, for example, with one or more optical lenses arranged along the X direction. Examples of the optical lenses may include a plano-convex lens, a plano-concave lens, a biconvex lens, a biconcave lens, a meniscus lens, an aspherical lens, and a freeform surface lens.

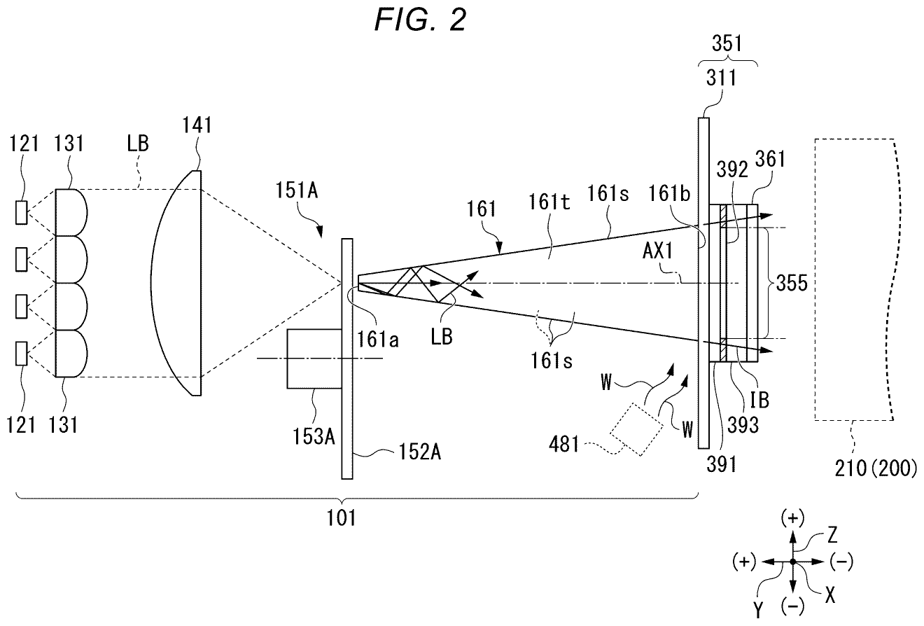

The configuration and other factors of the light guiding member of each of the color light emitters will next be described with reference to the blue light emitter 101 by way of example. FIG. 2 is an enlarged view of a portion of the projector 501, and is a schematic view of the blue light emitter 101 and the liquid crystal panel 351 viewed from the +X side toward the −X side along the X direction. Note in FIG. 2 that the substrate 111 is omitted.

The light guiding member 161 has a light incident surface 161a, the light exiting surface 161b, and side surfaces 161s, which couple the light incident surface 161a and the light exiting surface 161b to each other, as shown in FIG. 2.

The light incident surface 161a is the +Y-side end surface of the light guiding member 161, is parallel to the XZ plane, and is substantially similar to the shape of the spot of the blue light LB collected by the light collector 141 in the present embodiment. The shape of the light incident surface 161a may not be similar to the shape of the spot of the blue light LB. The light incident surface 161a viewed along the Y direction has, for example, a rectangular shape having long sides parallel to the X direction and short sides parallel to the Z direction, and may instead have a square shape.

The light exiting surface 161b is the −Y-side end surface of the light guiding member 161, is parallel to the XZ plane, and is substantially similar to the shape of the image formation region 355 of the liquid crystal panel 351. The light exiting surface 161b viewed along the Y direction has, for example, a rectangular shape having long sides parallel to the X direction and short sides parallel to the Z direction. The dimension of the image formation region 355 in the X direction is greater than the dimension of the image formation region 355 in the Z direction. The aspect ratio between the dimension of the light exiting surface 161b in the X direction and the dimension thereof in the Z direction corresponds to the aspect ratio between the dimension of the image formation region 355 in the X direction and the dimension thereof in the Z direction, and is, for example, 3:4, 4:5, or 9:16.

An imaginary line that couples the center of the light incident surface 161a and the center of the light exiting surface 161b is substantially parallel to the Y direction. The dimension of the light exiting surface 161b in the X direction is greater than the dimension of the light incident surface 161a in the X direction. The dimension of the light exiting surface 161b in the Z direction is greater than the dimension of the light incident surface 161a in the Z direction. The area of the light exiting surface 161b is greater than the area of the light incident surface 161a.

The light guiding member 161 has four side surfaces 161s. The first side surface 161s of the four side surfaces 161s links the +Z-side long side of the light incident surface 161a out of the two long sides parallel to the X direction to the +Z-side long side of the light exiting surface 161b out of the two long sides parallel to the X direction, and has a trapezoidal shape when viewed in the direction perpendicular to the first side surface 161s. The second side surface 161s of the four side surfaces 161s links the −Z-side long side of the light incident surface 161a out of the two long sides parallel to the X direction to the −Z-side long side of the light exiting surface 161b out of the two long sides parallel to the X direction, and has a trapezoidal shape when viewed in the direction perpendicular to the second side surface 161s. The third side surface 161s of the four side surfaces 161s links the +X-side long side of the light incident surface 161a out of the two short sides parallel to the Z direction to the +X-side short side of the light exiting surface 161b out of the two short sides parallel to the Z direction, and has a trapezoidal shape when viewed in the direction perpendicular to the third side surface 161s. The fourth side surface 161s of the four side surfaces 161s links the −X-side long side of the light incident surface 161a out of the two short sides parallel to the Z direction to the −X-side short side of the light exiting surface 161b out of the two short sides parallel to the Z direction, and has a trapezoidal shape when viewed in the direction perpendicular to the fourth side surface 161s.

The four side surfaces 161s each incline throughout the Y direction with respect to an optical axis AX1 of the blue light LB in the light guiding member 161. The optical axis AX1 corresponds to a first optical axis. The inclination angle of the side surfaces 161s with respect to the optical axis AX1 is what is called a taper angle, and is determined by the dimensions of the light incident surface 161a and the light exiting surface 161b and the length of the light guiding member 161 in the Y direction.

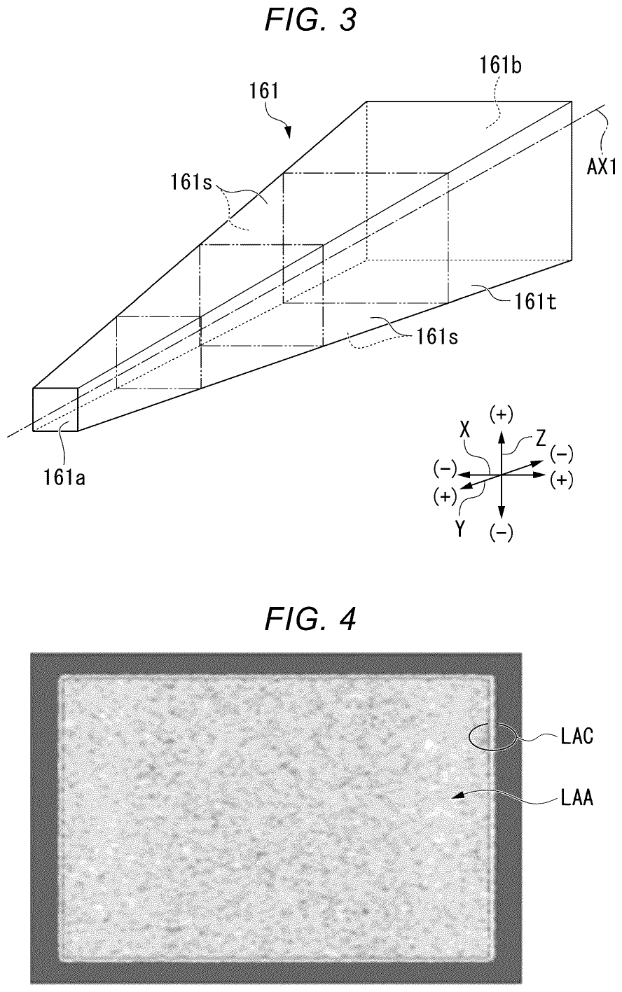

FIG. 3 is a perspective view of the light guiding member 161. The light guiding member 161 is a solid truncated quadrangular pyramid surrounded by the light incident surface 161a, the light exiting surface 161b, and the four side surfaces 161s, as shown in FIG. 3. The solid light guiding member 161 is made of a transparent material that transmits the blue light LB and dissipates heat generated by the blue light LB, satisfactorily preserves the polarization direction of the blue light LB, and has an appropriately high refractive index with respect to the air around the light guiding member 161, as described above. The light incident surface 161a corresponds to the upper surface of the truncated quadrangular pyramid. The light exiting surface 161b corresponds to the bottom surface of the truncated quadrangular pyramid. The length of the light guiding member 161 in the Y direction corresponds to the height of the truncated quadrangular pyramid.

The light guiding member 161 has the light incident surface 161a, the light exiting surface 161b, and an inclining section 161t. The inclining section 161t links the light incident surface 161a and the light exiting surface 161b to each other in the Y direction and is surrounded by the four side surfaces 161s in the XZ plane. The center axis of the light guiding member 161 and the inclining section 161t, which each has a truncated quadrangular pyramidal shape, is parallel to the Y direction, and further parallel to the entire optical axis AX1 of the blue light LB incident on the light incident surface 161a from the +Y side, totally reflected off the side surfaces 161s, and propagates through the inclining section 161t. Since the light exiting surface 161b is larger than the light incident surface 161a and the centers of the light incident surface 161a and the light exiting surface 161b coincide with each other in the XY plane as described above, the area of the cross section of the inclining section 161t that is parallel to the XZ plane, which intersects with the Y direction and the optical axis AX1, that is, the cross-sectional area of the inclining section 161t increases as the inclining section 161t extends from +Y side toward the −Y side.

Returning to FIG. 1, the blue light LB collected by the light collector 141 and output from the diffuser substrate 152A of the diffuser 151A as described above enters the light guiding member 161. The blue light LB is incident on the light incident surface 161a of the light guiding member 161 from the +Y side along the Y direction. In this process, the blue light LB diverges around the optical axis thereof parallel to the Y direction. The angle of incidence of the blue light LB incident on the light incident surface 161a and the angle of the blue light LB having entered the light guiding member 161 via the light incident surface 161a with respect to the optical axis are therefore not constant, and vary within a range according to the power of the light collector 141 and other factors.

The light guiding member 161 is configured with a transparent member having a refractive index higher than that of the surrounding air, as described above. Out of the blue light LB having entered the light guiding member 161 via the light incident surface 161a, the blue light LB having angles with respect to the optical axis AX1 being smaller than or equal to the taper angle of the side surfaces 161s directly reaches the light exiting surface 161b. Out of the blue light LB having entered the light guiding member 161 via the light incident surface 161a, the blue light LB having angles with respect to the optical axis AX1 being greater than the taper angle of the side surfaces 161s is reflected off the side surfaces 161s and reaches the light exiting surface 161b. When the blue light LB is totally reflected off the side surfaces 161s, the amount of the reflected blue light LB increases as compared with the amount in a case where the blue light LB is reflected off reflection films configured, for example, with dielectric multilayer films that are not shown but are provided at the side surface 161s. The number of times the blue light LB having angles with respect to the optical axis AX1 being greater than the taper angle of the side surfaces 161s is totally reflected off the side surfaces 161s varies depending on the angle of the blue light LB with respect to the optical axis AX1. The blue light LB traveling along different paths and having different angles of incidence is incident on the light exiting surface 161b, resulting in a homogenized illuminance distribution of the blue light LB at the light exiting surface 161b.

The blue light LB having the illuminance distribution homogenized in the XZ plane exits via the light exiting surface 161b toward the −Y side and directly enters the dustproof glass plate 311. The light exiting surface 161b in the XZ plane is sized to be larger than the image formation region 355 of the liquid crystal panel 351 by an illumination margin so set that the illumination margin surrounds the image formation region 355. The illumination margin in the blue light emitter 101 depends on the sizes of the dustproof glass plate 311 and a counter substrate 391 in the Y direction, that is, the thickness of the dustproof glass plate 311 and the thickness of the counter substrate 391.

To efficiently totally reflect the blue light LB off the side surfaces 161s to homogenize the illuminance distribution of the blue light LB at the light exiting surface 161b in the light guiding member 161, the taper angle of the side surfaces 161s is appropriately set in accordance with the refractive index of the transparent material of the light guiding member 161 and other factors. Examples of the transparent material of the light guiding member 161 may include quartz and optical glass as described above, and quartz is preferable because of its excellent light transparency and polarization reservation. When the light guiding member 161 is made of quartz, the taper angle of the side surfaces 161s ranges, for example, from about 9° to 12°.

The liquid crystal panel 351 includes the dustproof glass plate 311, the counter substrate 391, a liquid crystal layer 392, an element substrate 393, and the light-exiting-side polarizer plate 361, which are sequentially layered on each other from the +Y side toward the −Y side in the Y direction, as shown in FIG. 2. The dustproof glass plate 311 is disposed at the light incident side of the counter substrate 391, on which the blue light LB is incident, and corresponds to a light-incident-side dustproof member. The counter substrate 391, the liquid crystal layer 392, and the element substrate 393 are the pixel constituting portion of the liquid crystal panel 351, and constitute the multiple pixels.

The plate surfaces of the dustproof glass plate 311 is larger than the light exiting surface 161b of the light guiding member 161 in the X and Z directions. The +Z-side end of the dustproof glass plate 311 is located farther toward the +Z side than the +Z-side end of the light exiting surface 161b of the light guiding member 161 and the +Z-side end of the liquid crystal panel 351. The location of the −Z-side end of the dustproof glass plate 311 is shifted farther toward the −Z side than the −Z-side end of the light exiting surface 161b of the light guiding member 161 and the −Z-side end of the liquid crystal panel 351. Similarly, the ±X-side ends of the dustproof glass plate 311 are located farther toward the ±X side than the ±X-side end of the light exiting surface 161b of the light guiding member 161 and the ±X-side end of the liquid crystal panel 351. The centers of the plate surfaces of the dustproof glass plate 311 coincide with the optical axis AX1 of the blue light LB.

The counter substrate 391 corresponds to a first substrate. The plate surfaces of the counter substrate 391 are slightly larger than the light exiting surface 161b of the light guiding member 161 in the X and Z directions, but smaller than the plate surfaces of the dustproof glass plate 311, and is larger than at least the image formation region 355. The centers of the plate surfaces of the counter substrate 391 coincide with the optical axis AX1 of the blue light LB. The +Y-side plate surface of the counter substrate 391 is in contact with the −Y-side plate surface of the dustproof glass plate 311. Counter electrodes and other elements corresponding to the respective multiple pixels are formed at the −Y-side plate surface of the counter substrate 391.

The liquid crystal layer 392 is disposed in the image formation region 355 of the liquid crystal panel 351, has a rectangular shape that conforms to the image formation region 355 when viewed along the Y direction, and is sandwiched between the counter substrate 391 and the element substrate 393 in the Y direction. The liquid crystal layer 392 contains multiple liquid crystal molecules that are not shown. A layer structure that is not shown but constitutes a peripheral region of an electro-optical device that constitutes the liquid crystal panel 351 and a sealing material that is not shown but seals the liquid crystal layer 392 in the image formation region 355 are disposed around the liquid crystal layer 392 in the XZ plane.

The element substrate 393 corresponds to a second substrate. The plate surfaces of the element substrate 393 are the same size as those of the counter substrate 391 in the X and Z directions, and the element substrate 393 coincides with the counter substrate 391 when viewed along the Y direction. The centers of the plate surfaces of the element substrate 393 coincide with the optical axis AX1 of the blue light LB. Pixel electrodes and TFTs constituting the switching elements both corresponding to the multiple pixels, a liquid crystal alignment film, and the other elements are formed at the −Y-side plate surface of the element substrate 393. The +Y-side plate surface of the element substrate 393 is in contact with the −Y-side plate surface of the light-exiting-side polarizer plate 361. The element substrate 393 and the counter substrate 391 are formed in the same size and in the same rectangular shape when viewed along the Y direction, and are formed larger than the image formation region 355 in each of the X and Z directions. The element substrate 393 and the counter substrate 391 sandwich and support in the Y direction the liquid crystal layer 392 and the peripheral region structure including the layer structure constituting the peripheral region, which is not shown, and the sealing material.

The light-exiting-side polarizer plate 361 is disposed at the light exiting side of the element substrate 393, via which the blue light LB exits. The plate surfaces of the light-exiting-side polarizer plate 361 are the same size as those of the counter substrate 391 and the element substrate 393 in the X and Z directions, and the light-exiting-side polarizer plate 361 coincides with the counter substrate 391 and the element substrate 393 when viewed along the Y direction. The centers of the plate surfaces of the light-exiting-side polarizer plate 361 coincide with the optical axis AX1 of the blue light LB. The thus disposed light-exiting-side polarizer plate 361 prevents substances such as dust that block propagation of the blue light LB to the light combining member 200 from entering the pixel constituting portion of the liquid crystal panel 351 from the −Y side. The light-exiting-side polarizer plate 361 corresponds to a light-exiting-side dustproof member.

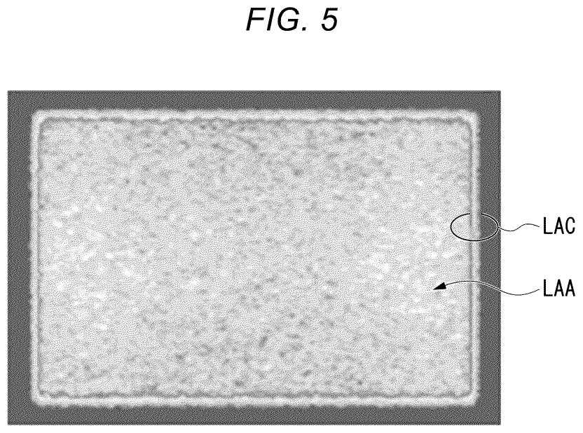

FIG. 4 is an image showing a result of numerical-simulation-based calculation of the illuminance distribution at the +Y-side light incident surface of the liquid crystal layer 392 of the liquid crystal panel 351 in a case where parameters relating to the dimensions and materials of the elements and the light guiding member 161 are appropriately set in the blue light emitter 101 having the configuration described above. FIG. 5 is an image showing a result of the numerical-simulation-based calculation of the illuminance distribution at the +Y-side light incident surface of the liquid crystal layer 392 of the liquid crystal panel 351 in a case where the length of the light guiding member 161 in the Y direction is reduced to shift the light exiting surface 161b of the light guiding member 161 toward the +Y side under the same conditions as those of the numerical simulation by which the image shown in FIG. 4 is acquired. The settings of the numerical simulation by which the image shown in FIG. 5 is acquired are the same as the settings of the numerical simulation by which the image shown in FIG. 4 is acquired in a state in which a gap of at least 3 μm or greater in the Y direction is provided between the light exiting surface 161b of the light guiding member 161 and the +Y-side plate surface of the dustproof glass plate 311.

The image shown in FIG. 4 and the image shown in FIG. 5 each have an effectively irradiated portion LAA and a peripheral portion LAC. The effectively irradiated portion LAA is a portion including a central portion of the region in the XZ plane irradiated with the blue light LB, and means a portion where the illuminance of the blue light LB falls within a predetermined illuminance range containing illuminance values of light with which the image formation region 355 of the liquid crystal panel 351 is supposed to be irradiated. The peripheral portion LAC means a portion which appears around the effectively irradiated portion LAA in the XZ plane and where the illuminance of the blue light LB is lower than the illuminance values within the predetermined illuminance range described above.

In the blue light emitter 101 and the projector 501 according to the first embodiment, since the light exiting surface 161b of the light guiding member 161 is in contact with the +Y-side plate surface of the dustproof glass plate 311, the separation distance in the Y direction between the light exiting surface 161b and the +Y-side light incident surface of the liquid crystal layer 392 of the liquid crystal panel 351 is suppressed to a value equal to the sum of the dimension of the dustproof glass plate 311 in the Y direction, that is, the thickness thereof, and the dimension of the counter substrate 391 of the liquid crystal layer 392 in the Y direction, that is, the thickness thereof. Comparison between the image shown in FIG. 4 and the image shown in FIG. 5 shows that the configuration of the blue light emitter 101 and the projector 501 shown in FIG. 4 secures a relatively wide effectively irradiated portion LAA irradiated with the blue light LB, and suppresses the peripheral portion LAC to a relatively narrow portion.

It is ascertained as shown in FIG. 5 that when a gap is created between the light exiting surface 161b of the light guiding member 161 and the +Y-side plate surface of the dustproof glass plate 311, as in the projector of related art, the effectively irradiated portion LAA irradiated with the blue light LB becomes relatively narrow and the peripheral portion LAC becomes relatively wide. When a gap is created between the light exiting surface 161b of the light guiding member 161 and the +Y-side plate surface of the dustproof glass plate 311, providing the effectively irradiated portion LAA having the same dimensions and area as those in the case where no gap is created as in the first embodiment requires enlarging the light exiting surface 161b of the light guiding member 161 in the X and Z directions. When the taper angle of the side surfaces 161s of the light guiding member 161 is substantially fixed, it is necessary to increase the size of the light guiding member 161. In addition, when a gap is created between the light exiting surface 161b of the light guiding member 161 and the +Y-side plate surface of the dustproof glass plate 311, the peripheral portion LAC is relatively wide with respect to the region irradiated with the blue light LB as compared with the case where the gap is not created, so that the blue light LB may be used at decreased efficiency.

From the result of the numerical simulation described above, the configuration in which the light exiting surface 161b of the light guiding member 161 is in contact with the +Y-side plate surface of the dustproof glass plate 311 suppresses an increase in the size of the light guiding member 161, relatively enlarges the effectively irradiated portion LAA irradiated with the blue light LB, relatively narrows the peripheral portion LVC, which is not effectively irradiated with the blue light LB, and increases the efficiency at which the blue light LB is used, that is, increases the amount of the light radiated to the image formation region 355 of the liquid crystal panel 351 and converted into the image light IB with respect to the blue light LB output from the light sources 121.

Returning to FIG. 2, the cooling fan 481 primarily supplies cooling air W toward an extension of the dustproof glass plate 311 that extends toward the −Z side beyond the −Z-side end of the light exiting surface 161b of the light guiding member 161. The configuration in which the −Z-side extension of the dustproof glass plate 311 receives the cooling air W from the cooling fan 481 cools the dustproof glass plate 311 from the −Z side toward the +Z side and from the −X side toward the +X side. The cooling air W from the cooling fan 481 may be supplied directly to the −Z-side extension of the dustproof glass plate 311 from the +Y side and the −Z side, or may be supplied via a duct or any other element that is not shown from the +Y side and the −Z side.

Note that the dustproof glass plate 311 also extends toward the +Z side and the ±X side beyond the light exiting surface 161b of the light guiding member 161. The cooling fan 481 may supply the cooling air W toward the extension of the dustproof glass plate 311 that extends toward either the +Z side or the ±X side beyond the light exiting surface 161b when viewed along the Y direction. The arrangement of the cooling fan 481 is determined as appropriate inside an enclosure or an exterior body of the projector 501 that is not shown.

The blue light LB output from the light guiding member 161 via the dustproof glass plate 311 is converted into the image light IB in the image formation region 355 of the liquid crystal panel 351. In this process, the liquid crystal panel 351 generates heat, which heats the counter substrate 391. The counter substrate 391 transfers the heat to the dustproof glass plate 311 cooled by the cooling air W from the cooling fan 481 as described above. The dustproof glass plate 311 is efficiently cooled as a whole by the cooling air W initially from the −Z-side end and then toward the +Z-side end through heat dissipation. As a result of the heat exchange between the dustproof glass plate 311 and the counter substrate 391 of the liquid crystal panel 351, the counter substrate 391 is cooled.

When the image light IB is generated in the image formation region 355 of the liquid crystal panel 351, the element substrate 393 is heated by a greater degree than the counter substrate 391. The element substrate 393 is cooled, for example, by a dedicated cooling fan that is not shown as in related art. Since the element substrate 393 is thus cooled and the counter substrate 391 is also cooled as described above, an excessive rise in temperature and deterioration of the performance of the liquid crystal panel 351 are suppressed, so that the blue light LB is converted into the image light IB at improved efficiency.

Part of the cooling air W from the cooling fan 481 is supplied to the −Z-side side surface 161s of the light guiding member 161 from the −Z side. The light guiding member 161 is thus also cooled in addition to the dustproof glass plate 311.

Although not shown, the green light emitter 102 and the red light emitter 103 are configured in the same principle as the blue light emitter 101 described above. The description of the green light emitter 102 should be made by replacing the light sources 121 with the light sources 122, the parallelizing elements 131 with the parallelizing elements 132, the light collector 141 with the light collector 142, the diffuser 151A with the diffuser 151B, the light guiding member 161 with the light guiding member 162, the light exiting surface 161b with the light exiting surface 162b, the blue light LB with the green light LG, the Y direction with the X direction, the XZ plane with the YZ plane, the +Y side with the −X side, and the −Y side with the +X side in the description of the blue light emitter 101.

The liquid crystal panel 352 is configured in the same principle as the liquid crystal panel 351 described above. The description of the liquid crystal panel 352 should be made by replacing the dustproof glass plate 311 with the dustproof glass plate 312, the light-exiting-side polarizer plate 361 with the light-exiting-side polarizer plate 362, the Y direction with the X direction, the XZ plane with the YZ plane, the +Y side with the −X side, and the −Y side with the +X side in the description of the liquid crystal panel 351. The counter substrate, the liquid crystal layer, and the element substrate of the liquid crystal panel 352 are sequentially arranged between the dustproof glass plate 312 and the light-exiting-side polarizer plate 362 from the −X side toward the +X side.

The description of the red light emitter 103 should be made by replacing the light sources 121 with the light sources 123, the parallelizing elements 131 with the parallelizing elements 133, the light collector 141 with the light collector 143, the diffuser 151A with the diffuser 151C, the light guiding member 161 with the light guiding member 163, the light exiting surface 161b with the light exiting surface 163b, the blue light LB with the green light LG, the +Y side with the −Y side, and the −Y side with the +Y side in the description of the blue light emitter 101.

The liquid crystal panel 353 is configured in the same principle as the liquid crystal panel 351 described above. The description of the liquid crystal panel 353 should be made by replacing the dustproof glass plate 311 with the dustproof glass plate 313, the light-exiting-side polarizer plate 361 with the light-exiting-side polarizer plate 363, the +Y side with the −Y side, and the −Y side with the +Y side in the description of the liquid crystal panel 351. The counter substrate, the liquid crystal layer, and the element substrate of the liquid crystal panel 353 are sequentially arranged between the dustproof glass plate 313 and the light-exiting-side polarizer plate 363 from the −Y side toward the +Y side.

Returning to FIG. 1, the cooling fan 482 primarily supplies cooling air (air) toward an extension of the dustproof glass plate 312 that extends toward the −Z side beyond the −Z-side end of the light exiting surface 162b of the light guiding member 162. The configuration in which the −Z-side extension of the dustproof glass plate 312 receives the cooling air from the cooling fan 482 cools the dustproof glass plate 312. The cooling air W from the cooling fan 482 may be supplied directly to the −Z-side extension of the dustproof glass plate 312 from the −X side and the −Z side, or may be supplied via a duct or any other element that is not shown from the −X side and the −Z side. The cooling fan 482 may supply the cooling air toward the extension of the dustproof glass plate 312 that extends toward either the +Z side or the ±Y side beyond the light exiting surface 162b when viewed along the X direction. The arrangement of the cooling fan 482 is determined as appropriate inside the enclosure or the exterior body of the projector 501 that is not shown, as that of the cooling fan 481.

The dustproof glass plate 312 is efficiently cooled as a whole by the cooling air from the cooling fan 482 initially from the −Z-side end and then toward the +Z-side end. As a result of the heat exchange between the dustproof glass plate 312 and the counter substrate of the liquid crystal panel 352, the counter substrate of the liquid crystal panel 352 is cooled.

When the image light IG is generated in the image formation region 356 of the liquid crystal panel 352, the element substrate of the liquid crystal panel 352 is heated by a greater degree than the counter substrate. The element substrate of the liquid crystal panel 352 is cooled, for example, by a dedicated cooling fan that is not shown as in related art. Since the element substrate and the counter substrate of the liquid crystal panel 352 are cooled, an excessive rise in temperature and deterioration of the performance of the liquid crystal panel 352 are suppressed, so that the green light LG is converted into the image light IG at improved efficiency.

Since part of the cooling air from the cooling fan 482 is supplied from the −Z side to the −Z-side side surface of the light guiding member 162, the light guiding member 162 is also cooled in addition to the dustproof glass plate 312.

The cooling fan 483 primarily supplies cooling air (air) toward an extension of the dustproof glass plate 313 that extends toward the −Z side beyond the −Z-side end of the light exiting surface 163b of the light guiding member 163. The configuration in which the −Z-side extension of the dustproof glass plate 313 receives the cooling air from the cooling fan 483 cools the dustproof glass plate 313. The cooling air from the cooling fan 483 may be supplied directly to the −Z-side extension of the dustproof glass plate 313 from the −X side and the −Z side, or may be supplied via a duct or any other element that is not shown from the −X side and the −Z side. The cooling fan 483 may supply the cooling air toward the extension of the dustproof glass plate 313 that extends toward either the +Z side or the ±X side beyond the light exiting surface 163b when viewed along the Y direction. The arrangement of the cooling fan 483 is determined as appropriate inside the enclosure or the exterior body of the projector 501 that is not shown, as that of the cooling fan 481.

The dustproof glass plate 313 is efficiently cooled as a whole by the cooling air from the cooling fan 483 initially from the −Z-side end and then toward the +Z-side end. As a result of the heat exchange between the dustproof glass plate 313 and the counter substrate of the liquid crystal panel 353, the counter substrate of the liquid crystal panel 353 is cooled.

When the image light IR is generated in the image formation region 357 of the liquid crystal panel 353, the element substrate of the liquid crystal panel 353 is heated by a greater degree than the counter substrate. The element substrate of the liquid crystal panel 353 is cooled, for example, by a dedicated cooling fan that is not shown as in related art. Since the element substrate and the counter substrate of the liquid crystal panel 353 are cooled, an excessive rise in temperature and deterioration of the performance of the liquid crystal panel 353 are suppressed, so that the red light LR is converted into the image light IR at improved efficiency.

Since part of the cooling air from the cooling fan 483 is supplied from the −Z side to the −Z-side side surface of the light guiding member 163, the light guiding member 163 is also cooled in addition to the dustproof glass plate 313.

The projector 501 according to the first embodiment described above includes the light sources (first light source) 121, the light collector (first light collector) 141, the light guiding member (first light guiding member) 161, and the liquid crystal panel (first liquid crystal panel) 351. The light sources 121 each output the linearly polarized blue light (first light) LB. The light collector 141 collects the blue light LB output from the light sources 121. The light guiding member 161 guides the blue light LB output from the light collector 141. The liquid crystal panel 351 modulates the blue light LB output from the light guiding member 161 to generate the image light IB. The light guiding member 161 has the light incident surface 161a, the light exiting surface 161b, and the inclining section 161t. The blue light LB output from the light collector 141 is incident on the light incident surface 161a. The blue light LB exits via the light exiting surface 161b toward the liquid crystal panel 351. The inclining section 161t has the side surfaces (inclining surfaces) 161s, which incline with respect to the optical axis (first optical axis) AX1 of the light guiding member 161. The area (cross-sectional area) of a cut surface of the inclining section 161t that intersects with the Y direction parallel to the optical axis AX1 increases as the inclining section 161t extends toward the −Y side along the Y direction in which the blue light LB is guided (direction in which first light is guided). In the projector 501 according to the first embodiment, the light exiting surface 161b of the light guiding member 161 and a portion of the light incident side of the liquid crystal panel 351, on which the blue light LB is incident, (portion of light incident side) are in contact with each other. For example, the portion of the light incident side of the liquid crystal panel 351, on which the blue light LB is incident, is the portion of the +Y-side plate surface of the dustproof glass plate 311 on which the blue light LB is incident and which is a region (portion) that coincides with the light exiting surface 161b of the light guiding member 161 and contains the center of the +Y-side plate surface of the dustproof glass plate 311 when viewed along the Y direction.

In the projector 501 according to the first embodiment, the blue light LB output from the light sources 121, the green light LG output from the light sources 122, and the red light LR output from the light sources 123 are not combined with one another. The blue light LB enters the liquid crystal panel 351 for blue light via the optical system including the light guiding member 161. The green light LG enters the liquid crystal panel 352 for green light via the optical system including the light guiding member 162. The red light LR enters the liquid crystal panel 353 for red light via the optical system including the light guiding member 163.

In the projector 501 according to the first embodiment, since the −Y-side light exiting surface 161b of the light guiding member 161 and a portion of the +Y-side plate surface of the dustproof glass plate 311 of the liquid crystal panel 351 are in contact with each other, leakage of the blue light LB in the Y direction and in the XZ plane to the space outside the light guiding member 161 and the liquid crystal panel 351 is suppressed, so that the blue light LB output from the light guiding member 161 efficiently enters the liquid crystal panel 351.

In the projector 501 according to the first embodiment, the state in which the light exiting surface 161b of the light guiding member 161 and the portion of the +Y-side plate surface of the dustproof glass plate 311 are in contact with each other includes a state in which the light exiting surface 161b and the portion of the +Y-side plate surface of the dustproof glass plate 311 have the same flatness and two types of minute unevenness in the XZ plane similar to each other and the two surfaces are entirely in contact with each other. The state in which the light exiting surface 161b and the portion of the +Y-side plate surface of the dustproof glass plate 311 are in contact with each other also includes a state in which one of the light exiting surface 161b and the portion of the +Y-side plate surface of the dustproof glass plate 311 has flatness different from that of the other and minute unevenness in the XZ plane different from that of the other and the separation distance in the Y direction between the light exiting surface 161b and the portion of the +Y-side plate surface of the dustproof glass plate 311 varies. The separation distance in this case is, for example, greater than or equal to 0 μm but smaller than or equal to 3 μm, and preferably smaller than or equal to 1 μm.

The projector 501 according to the first embodiment allows the blue light LB output from the light sources 121 is used at increased efficiency. The following description of the effects and advantages provided by the blue light emitter 101 and the cooling fan 481 of the projector 501 according to the first embodiment also holds true for each of the green light emitter 102 and the red light emitter 103 configured in the same manner as the blue light emitter 101. The projector 501 according to the first embodiment therefore allows the green light LG output from the light sources 122 and the red light LR output from the light sources 123 each to be used at increased efficiency, in addition to the blue light LB output from the light sources 121.

In a known first projector of related art, for example, light emitting diodes (LEDs) are used as the light source, tapered rod members (light guiding member) increase how much the light beams output from the multiple LEDs are parallelized, and the light beams output from the rod members are separated in terms of polarization by polarization converters each including a polarizing beam splitter. The light beams separated in terms of polarization are combined with one another by a light combining member, and the combined light enters a liquid crystal cell (liquid crystal panel), which converts the light into image light, which is projected, for example, by a projection system (JP-A-2008-083661, for example). In the first projector, the light exiting surfaces of the rod members and the light incident surfaces of the cube-shaped polarizing beam splitters of the polarization converters are in contact with each other.

In the first projector of related art, a gap is provided between the light exiting surfaces of the polarizing beam splitters and the light incident surface of the liquid crystal cell. Therefore, in the optical path of the light emitted from each of the LEDs, the separation distance between the light exiting surface of the rod member and the light incident surface of the liquid crystal cell is at least greater than or equal to the sum of the thickness of the polarizing beam splitter and the separation distance between the light exiting surface of the polarizing beam splitter and the light incident surface of the liquid crystal cell, and is considerably greater than the thickness of each of a known dustproof glass plate of the liquid crystal cell, the light-incident-side polarizer plate, the counter substrate, and other elements. As a result, in the first projector of related art, there is a possibility of light leakage through the gap between the polarizing beam splitters and the liquid crystal cell, and an illumination margin is relatively large with respect to an image formation region of the liquid crystal cell.

In the blue light emitter 101 of the projector 501 according to the first embodiment, the −Y-side light exiting surface 161b of the light guiding member 161 and a portion of the +Y-side plate surface of the dustproof glass plate 311 of the liquid crystal panel 351 are in contact with each other, as described above. The separation distance between the light exiting surface 161b and the liquid crystal layer 392 of the liquid crystal panel 351 in the Y direction is therefore suppressed to a value equal to the sum of the thickness of the dustproof glass plate 311 and the thickness of the counter substrate 391. The illumination margin with respect to the image formation region 355 is relatively smaller than that in the first projector of related art. Similarly, the illumination margin with respect to each of the image formation region 356 of the green light emitter 102 and the image formation region 357 of the red light emitter 103 is relatively smaller than that in the first projector of related art. The projector 501 according to the first embodiment prevents leakage of the color light between each of the light guiding members 161, 162, and 163 and the corresponding one of the dustproof glass plates 311, 312, and 313 of the liquid crystal panels 351, 352, and 353, and suppresses the illumination margin with respect to each of the image formation regions 355, 356, and 357 to a small region to allow the blue light LB, the green light LG, and the red light LR each to be used at increased efficiency.

In a second projector of related art, for example, the illuminance distributions of blue light, green light, and red light output from a blue LED light source, a green LED light source, and a red LED light source are homogenized by individual tapered rod lenses (light guiding members). The color light output from each of the tapered rod lenses enters a liquid crystal light valve (liquid crystal panel) via a reflective polarizer configured with a wire grid polarizer (WGP), which converts the color light into image light, which is projected, for example, by a projection system (JP-A-2005-234440, for example). In the second projector, the light-exiting-side end surface of each of the tapered rod lenses and the WGP are in contact with each other.

The second projector of related art can prevent the light from leaking through the gap between the end surfaces and the WGP in the direction along the optical path, and can therefore suppress a decrease in the light use efficiency due to the light leakage through the gap described above. However, since the color light output from each of the tapered rod lenses passes through the WGP, which lowers the light use efficiency.

In the blue light emitter 101 of the projector 501 according to the first embodiment, the −Y-side light exiting surface 161b of the light guiding member 161 and the portion of the +Y-side plate surface of the dustproof glass plate 311 of the liquid crystal panel 351 are in contact with each other, and no polarizer plate is disposed between the light guiding member 161 and the +Y-side substrate of the liquid crystal panel 351, that is, the counter substrate 391, as described above. The projector 501 according to the first embodiment, in which no polarizer plate is disposed at the light incident side of each of the liquid crystal panels 351, 352, and 353, does not experience a decrease in light use efficiency due to light loss caused by absorption or reflection at the polarizer plate at the incident side of each of the liquid crystal panels, unlike the second projector of related art, and therefore allows the blue light LB, the green light LG, and the red light LR to be used at increased efficiency.

A third projector of related art includes, for example, a light source apparatus including a light source section including an LD light source, a phosphor serving as a wavelength converter that converts the wavelength of the light output from the light source section, a light guide (light guiding member) that guides the light emitted from the phosphor, a reflective polarizer that adjusts the polarization direction of the light output from the light guide, and a reflection mirror disposed so as to surround a portion of the light guide that is closer to the light incident side thereof than an intermediate position therein. In the third projector of related art, the light output from the reflective polarizer enters the light guide via the light exiting surface thereof, propagates toward the light incident surface thereof, and contributes to re-excitation of the phosphor. The light exiting surface of the light guide is not in contact with the reflective polarizer and is therefore disposed at a distance from the reflective polarizer.

In the third projector of related art, a liquid crystal light valve (liquid crystal panel) is disposed at the side opposite the light guide with respect to the reflective polarizer at a distance from the reflective polarizer. Therefore, in the optical path of the light output from the light source section, the separation distance between the light exiting surface of the light guide and the light incident surface of the liquid crystal light valve is at least greater than or equal to the sum of the separation distance between the light exiting surface of the light guide and the light incident surface of the reflective polarizer, the thickness of the reflective polarizer, and the separation distance between the light exiting surface of the reflective polarizer and the light incident surface of the liquid crystal light valve, and is considerably greater than the thickness of each of a known dustproof glass plate of the liquid crystal light valve, the light-incident-side polarizer plate, the counter substrate, and other elements. As a result, in the third projector of related art, there is a possibility of light leakage through the gap between the light guide and the reflective polarizer and the gap between the reflective polarizer and the liquid crystal light valve, and an illumination margin with respect to an image formation region of the liquid crystal light valve is relatively large. In addition, in the third projector of related art, the reflective polarizer is disposed at the light incident side of the liquid crystal light valve, and part of the incident light is reflected off the reflective polarizer and therefore does not enter the liquid crystal light valve, resulting in a decrease in the light use efficiency.

The projector 501 according to the first embodiment prevents the leakage of the color light through the space between each of the light guiding members 161, 162, and 163 and the corresponding one of the dustproof glass plates 311, 312, and 313 of the liquid crystal panels 351, 352, and 353, suppresses the illumination margin with respect to each of the image formation regions 355, 356, and 357 to a small region, and eliminates a need to consider loss of the color light at the polarizer at the light incident side of each of the liquid crystal panels 351, 352, and 353, so that the blue light LB, the green light LG, and the red light LR can be used at increased efficiency, as described above.

In the projector 501 according to the first embodiment, the linearly polarized blue light LB output from the light sources 121 enters the liquid crystal panel 351 without any change in the polarization direction of the blue light LB between the light sources 121 and the liquid crystal panel 351, for example, without any change due to a polarizer plate or a polarizer other than a polarizer plate between the light sources 121 and the liquid crystal panel 351. That is, the polarization direction of the blue light LB is preserved between the light exiting surface of each of the light sources 121 and the light incident surface of the liquid crystal layer 392 of the liquid crystal panel 351.

The projector 501 according to the first embodiment can minimize the loss of the amount of the blue light LB that enters the liquid crystal layer 392 of the liquid crystal panel 351.

In the projector 501 according to the first embodiment, the light guiding member 161 perpendicular to the optical axis AX1 has a quadrangular cross sectional shape. The light exiting surface 161b of the light guiding member 161 has a rectangular shape. The polarization direction of the linearly polarized blue light LB is the direction along one of the X direction (direction of long sides) and the Z direction (direction of short sides) of the rectangular shape of the light exiting surface 161b.

In the projector 501 according to the first embodiment, when the blue light LB is output from the light sources 121 and enters the light guiding member 161, the polarization direction of the blue light LB is along the X or Z direction, which is suitable as the polarization direction of the blue light LB to be incident on the image formation region 355 of the liquid crystal panel 351. The projector 501 according to the first embodiment can minimize the loss of the amount of the blue light LB caused in the path along which the blue light LB is guided by the light guiding member 161 and enters the liquid crystal layer 392 of the liquid crystal panel 351, readily control the blue light LB at each of the pixels in the image formation region 355 of the liquid crystal panel 351, and generate the image light LB.

In the projector 501 according to the first embodiment, the liquid crystal panel 351 has the image formation region 355 in which multiple pixels are arranged. The liquid crystal panel 351 includes the counter substrate (first substrate) 391, the liquid crystal layer 392, the element substrate (second substrate) 393, the dustproof glass plate (light-incident-side dustproof member) 311, and the light-exiting-side polarizer plate (light-exiting-side dustproof member) 361. The element substrate 393 faces the counter substrate 391 via the liquid crystal layer 392. The dustproof glass plate 311 is disposed at the +Y side (light incident side) of the counter substrate 391. The light-exiting-side polarizer plate 361 is disposed at the −Y side (light exiting side) of the element substrate 393. In the projector 501 according to the first embodiment, the light exiting surface 161b of the light guiding member 161 is in contact with the dustproof glass plate 311.

Specifically, in the projector 501 according to the first embodiment, the dustproof glass plate 311, which is disposed at a position closest to the +Y side in the liquid crystal panel 351, has a portion that overlaps with the light exiting surface 161b of the light guiding member 161 when viewed along the Y direction in the XY plane, and the portion is in contact with the light exiting surface 161b. The projector 501 according to the first embodiment, can suppress the gap between the light exiting surface 161b of the light guiding member 161 and the light incident surface of the liquid crystal layer 392 of the liquid crystal panel 351 to a value equal to the sum of the thickness of the dustproof glass plate 311 and the thickness of the counter substrate 391 in the Y direction parallel to the optical axis AX1 of the blue light LB. As a result, the leakage of the color light between the light guiding member 161 and the dustproof glass plate 311 can be satisfactorily prevented, so that the illumination margin with respect to the image formation region 355 can be suppressed to a small region.

The projector 501 according to the first embodiment further includes the cooling fan 481, which delivers the cooling air (air) W to the liquid crystal panel 351. In the projector 501 according to the first embodiment, the planar size of the dustproof glass plate 311 viewed along the optical axis AX1 of the blue light LB and the Y direction, that is, the size in the XY plane is greater than the planar size of each of the counter substrate 391, the element substrate 393, and the light-exiting-side polarizer plate 361. The cooling fan 481 delivers the cooling air W to the dustproof glass plate 311.

In the projector 501 according to the first embodiment, the cooling air W is delivered from the cooling fan 481 to the extension of the dustproof glass plate 311, which is larger than the counter substrate 391, the element substrate 393, and the light-exiting-side polarizer plate 361 when viewed along the Y direction. The cooling air W from the cooling fan 481 primarily directly cools the dustproof glass plate 311, and indirectly cools the light guiding member 161 and the counter substrate 391, which are in contact with the dustproof glass plate 311. The element substrate 393 is cooled in the same manner as in related art. As a result, an excessive rise in temperature and failure in the operation of the liquid crystal panel 351 due to the radiation of the blue light LB are prevented. The projector 501 according to the first embodiment effectively suppresses deterioration of the performance of the liquid crystal panel 351, and allows long-term use of the liquid crystal panel 351.

In the projector 501 according to the first embodiment, the cooling fan 481 delivers the cooling air W also to the light guiding member 161.

In the projector 501 according to the first embodiment, the light guiding member 161 is cooled by part of the cooling air W from the cooling fan 481. The projector 501 according to the first embodiment can receive heat from the dustproof glass plate 311 of the liquid crystal panel 351 in contact with the light guiding member 161 and efficiently dissipate the heat via the light guiding member 161 having a surface area greater than that of the dustproof glass plate 311. In addition, the projector 501 according to the first embodiment can suppress disturbance of the polarization direction of the blue light LB propagating through the interior of the light guiding member 161.

The projector 501 according to the first embodiment further includes the diffuser (first diffuser) 151A. The diffuser 151A includes the diffuser substrate 152A, which diffusively outputs the incident blue light LB, and the driver 153A, which rotates the diffuser substrate 152A. The diffuser 151A is disposed between the light collector 141 and the light guiding member 161 in the Y direction parallel to the optical axis AX1 of the blue light LB.

In the projector 501 according to the first embodiment, the illuminance distribution, in the XZ plane, of the blue light LB that enters the light guiding member 161 is diffused by the rotating diffuser substrate 152A in the diffuser 151A. The projector 501 according to the first embodiment can homogenize in advance the illuminance of the blue light LB that enters the light guiding member 161, and increase the uniformity of the illuminance distribution of the blue light LB output via the light exiting surface 161b of the light guiding member 161.

The projector 501 according to the first embodiment further includes the light sources (second light source) 122, the light collector (second light collector) 142, the light guiding member (second light guiding member) 162, and the liquid crystal panel (second liquid crystal panel) 352. The light sources 122 each output the linearly polarized green light (second light) LG, which belongs to the green wavelength band (second wavelength band) different from the blue wavelength band to which the blue light LB belongs. The light collector 142 collects the green light LG output from the light sources 122. The light guiding member 162 guides the green light LG output from the light collector 142. The liquid crystal panel 352 modulates the green light LG output from the light guiding member 162 to generate the image light IG. Although not shown, the light guiding member 162 has a light incident surface parallel to the YZ plane, the light exiting surface (second exiting surface) 162b, and an inclining section (second inclined portion). The green light LG output from the light collector 142 is incident on the light incident surface of the light guiding member 162. The green light LG exits via the light exiting surface 162b toward the liquid crystal panel 352. The inclining section of the light guiding member 162 has an inclining surface that inclines with respect to the XY plane and the optical axis (second optical axis) of the light guiding member 162 that is parallel to the X direction. The area of a cross section of the second inclining section taken along the X direction increases as the second inclining section extends toward the +X side along the X direction, in which the green light LG is guided (direction in which second light is guided). In the projector 501 according to the first embodiment, the light exiting surface 162b of the light guiding member 162 and a portion of the light incident side of the liquid crystal panel 352, on which the green light LG is incident, (portion of light incident side) are in contact with each other. For example, the portion of the light incident side of the liquid crystal panel 352, on which the green light LG is incident, is the portion of the −X-side plate surface of the dustproof glass plate 312 on which the green light LG is incident and which is a region (portion) that coincides with the light exiting surface 162b of the light guiding member 162 and contains the center of the −X-side plate surface of the dustproof glass plate 312 when viewed along the X direction.

The projector 501 according to the first embodiment further includes the light sources 123, which output the red light LR, the light collector 143, the light guiding member 163, and the liquid crystal panel 353. Although not shown, the light guiding member 163 has a light incident surface parallel to the XZ plane, the light exiting surface 163b, and an inclining section. The red light LR output from the light collector 143 is incident on the light incident surface of the light guiding member 163. The red light LR exits via the light exiting surface 163b toward the liquid crystal panel 353. The inclining section of the light guiding member 163 has an inclining surface that inclines with respect to the XY plane and the optical axis of the red light LR parallel to the Y direction of the light guiding member 163. The area of a cross section of the light guiding member 163 taken along the X direction increases as the light guiding member 163 extends toward the +Y side along the Y direction, in which the red light LR is guided. In the projector 501 according to the first embodiment, the light exiting surface 163b of the light guiding member 163 and a portion of the light incident side of the liquid crystal panel 353, on which the red light LR is incident, are in contact with each other. For example, the portion of the light incident side of the liquid crystal panel 353, on which the red light LR is incident, is the portion of the −Y-side plate surface of the dustproof glass plate 313 on which the red light LR is incident and which is a region that coincides with the light exiting surface 163b of the light guiding member 163 and contains the center of the −Y-side plate surface of the dustproof glass plate 313 when viewed along the Y direction.

In the projector 501 according to the first embodiment, since the +X-side light exiting surface 162b of the light guiding member 162 and the portion of the −X-side plate surface of the dustproof glass plate 312 of the liquid crystal panel 352 are in contact with each other, leakage of the green light LG in the X direction and in the YZ plane to the space outside the light guiding member 162 and the liquid crystal panel 352 is suppressed, so that the green light LG output from the light guiding member 162 efficiently enters the liquid crystal panel 352. Furthermore, since the +Y-side light exiting surface 163b of the light guiding member 163 and the portion of the −Y-side plate surface of the dustproof glass plate 313 of the liquid crystal panel 353 are in contact with each other, leakage of the red light LR in the Y direction and in the XZ plane to the space outside the light guiding member 163 and the liquid crystal panel 353 is suppressed, so that the red light LR output from the light guiding member 163 efficiently enters the liquid crystal panel 353. The projector 501 according to the first embodiment therefore allows the blue light LB output from the light sources 121, the green light LG output from the light sources 122, and the red light LR output from the light sources 123 each to be used at increased efficiency, and therefore allows an increase in brightness of each of the blue light LB, the green light LG, and the red light LR.

### Variation of First Embodiment

A variation of the first embodiment of the present disclosure will next be described. Although not shown, in the variation of the projector 501 according to the first embodiment, an air layer is provided in the Y direction between the +Y-side plate surface of the dustproof glass plate 311 of the liquid crystal panel 351 and the −Y-side end surface of the light guiding member 161 of the blue light emitter 101, that is, the light exiting surface 161b. Note in the present specification that the air layer is not shown.

The thickness of the air layer in the Y direction, that is, the separation distance between the light exiting surface 161b and the +Y-side plate surface of the dustproof glass plate 311 is smaller than or equal to 3 μm, preferably smaller than or equal to 1 μm. The upper limit of the separation distance of 3 μm is a dimension obtained by intensive studies and findings conducted and achieved by the applicant of the present disclosure using a numerical simulation or the like as the separation distance that suppresses leakage of the blue light LB as in the state in which the light guiding member 161 and the dustproof glass plate 311 are in contact with each other, that is, the state in which the separation distance is 0 μm, and provides a state regarded as substantially the same as the state in which the light guiding member 161 and the dustproof glass plate 311 are in contact with each other to allow the heat propagation and heat dissipation as in the state in which the separation distance is 0 μm.

The variation of the projector 501 according to the first embodiment includes a state in which the light exiting surface 161b and the portion (part) of the +Y-side plate surface of the dustproof glass plate 311 that overlaps with the light exiting surface 161b when viewed at least along the Y direction have the same flatness and two types of minute unevenness in the XZ plane similar to each other and the two surfaces are entirely in contact with each other. The variation of the projector 501 also includes a state in which one of the light exiting surface 161b and the portion of the +Y-side plate surface of the dustproof glass plate 311 has flatness different from that of the other and minute unevenness in the XZ plane different from that of the other and the separation distance in the Y direction between the light exiting surface 161b and the portion of the +Y-side plate surface of the dustproof glass plate 311 varies, as in the first embodiment. The separation distance in this case is, for example, greater than 0 μm but smaller than or equal to 3 μm, and preferably smaller than or equal to 1 μm.

The variation of the projector 501 according to the first embodiment includes the light sources (first light source) 121, the light collector (first light collector) 141, the light guiding member (first light guiding member) 161, and the liquid crystal panel (first liquid crystal panel) 351. In the variation of the projector 501 according to the first embodiment, the air layer having the thickness of 3 μm or smaller is provided between the light exiting surface 161b of the light guiding member 161 and a portion of the light incident side of the liquid crystal panel 351, on which the blue light LB is incident, (portion of light incident side).

In the variation of the projector 501 according to the first embodiment, since the thickness of the air layer between the light exiting surface 161b of the light guiding member 161 and the portion of the +Y-side plate surface of the dustproof glass plate 311 of the liquid crystal panel 351 is 3 μm or smaller, leakage of the blue light LB in the Y direction and in the XZ plane to the space outside the light guiding member 161 and the liquid crystal panel 351 is suppressed in substantially the same manner as the state in which the light exiting surface 161b and the portion of the +Y-side plate surface of the dustproof glass plate 311 are in contact with each other. When the image light IB is generated, the liquid crystal panel 351 generates heat, which heats the counter substrate 391. Since the thickness of the air layer between the light exiting surface 161b and the portion of the +Y-side plate surface of the dustproof glass plate 311 is suppressed to 3 μm or smaller, the heat exchange and heat dissipation between the counter substrate 391 and the dustproof glass plate 311 and between the dustproof glass plate 311 and the light guiding member 161 are performed in substantially the same manner as the state in which the light exiting surface 161b and the portion of the +Y-side plate surface of the dustproof glass plate 311 are in contact with each other, and the dustproof glass plate 311 is efficiently cooled as a whole including the −Z side end portion. Furthermore, in the variation of the projector 501 according to the first embodiment, the illumination margin with respect to each of the image formation regions 355, 356, and 357 is satisfactorily suppressed. Moreover, since no polarizer plate is disposed at the light incident side of each of the liquid crystal panels 351, 352, and 353, no polarizer plate causes no decrease in the light use efficiency at the light incident side of each of the liquid crystal panels 351, 352, and 353. Therefore, in the variation of the projector 501 according to the first embodiment, the blue light LB output from the light guiding member 161 efficiently enters the liquid crystal panel 351, the green light LG output from the light guiding member 162 efficiently enters the liquid crystal panel 352, and the red light LR output from the light guiding member 163 efficiently enters the liquid crystal panel 353. The variation of the projector 501 according to the first embodiment allows the blue light LB, the green light LG, and the red light LR each to be used at increased efficiency.

The variation of the projector 501 according to the first embodiment can provide effects and advantages achieved by the configurations common to those of the projector 501.

### Second Embodiment

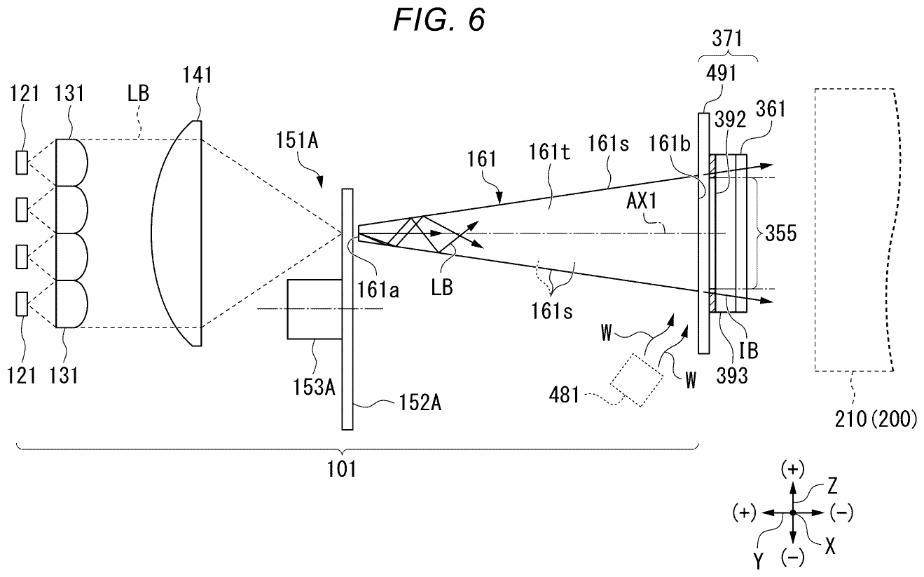

A second embodiment of the present disclosure will next be described with reference to FIG. 6. In the description of the second embodiment and variations thereof, contents common to those in the first embodiment and the variation thereof are omitted, and configurations common to those of the projector 501 according to the first embodiment have the same reference characters of the relevant configurations of the projector 501. In the description of the second embodiment and variations thereof, only configurations and contents different from those already described in the first embodiment and the variation thereof will be described.

Although not shown, the projector according to the second embodiment of the present disclosure includes the blue light emitter 101, the green light emitter 102, the red light emitter 103, a liquid crystal panel 371 for the blue light LB, a liquid crystal panel for the green light LG, a liquid crystal panel for the red light LR, the light combining member 200, the projection system 450, and the cooling fans 481, 482, and 483, as the projector 501 according to the first embodiment.

FIG. 6 is an enlarged view of a portion of the projector according to the second embodiment, and is a schematic view of the blue light emitter 101 and the liquid crystal panel 371 viewed from the +X side toward the −X side along the X direction. Note in FIG. 2 that the substrate 111 is omitted.

The liquid crystal panel 371 in the second embodiment is similar to the liquid crystal panel 351 for the blue light LB in the projector 501 according to the first embodiment but different therefrom in that the dustproof glass plate 311 is removed and the counter substrate 391 is enlarged in the X and Z directions, and that a counter substrate 491, the liquid crystal layer 392, the element substrate 393, and the light-exiting-side polarizer plate 361 are sequentially layered on each other from the +Y side toward the −Y side in the Y direction, as shown in FIG. 6.

In the second embodiment, the counter substrate 491 is disposed at a position where the counter substrate 491 overlaps with the light guiding member 161 in the X and Z directions, and which is closest to +Y side in the liquid crystal panel 371. The +Y-side plate surface of the counter substrate 491 is in contact with the −Y-side end surface of the light guiding member 161, that is, the light exiting surface 161b. The counter substrate 491 prevents substances such as dust that block propagation of the blue light LB to the light combining member 200 from entering the pixel constituting portion of the liquid crystal panel 371 from the +Y side. The counter substrate 491 is primarily made of a material that transmits light that belongs to at least the blue wavelength band out of the visible wavelength band, and is preferably made of a material that excels in heat dissipation. The material of the counter substrate 491 is, for example, quartz, optical glass, or the like, and is preferably sapphire, which excels in light transparency and heat dissipation.

The counter substrate 491 corresponds to the first substrate. The plate surfaces of the counter substrate 491 are obviously larger than the light exiting surface 161b of the light guiding member 161 in the X and Z directions, but equal in size to the plate surfaces of the dustproof glass plate 311 in the first embodiment, and is at least larger than the image formation region 355. The centers of the plate surfaces of the counter substrate 491 coincide with the optical axis AX1 of the blue light LB.

Note that the counter substrate 491 extends toward the ±Z side and the ±X side beyond the light exiting surface 161b of the light guiding member 161. The cooling fan 481 supplies the cooling air W toward the extension of the counter substrate 491 that extends toward the −Z side beyond the light exiting surface 161b when viewed along the Y direction. Note that the cooling fan 481 may supply the cooling air W toward the extension of the counter substrate 491 that extends toward either the +Z side or the ±X side beyond the light exiting surface 161b when viewed along the Y direction.

The blue light LB output from the light guiding member 161 passes through the counter substrate 491 of the liquid crystal panel 371, and is converted into the image light IB by the liquid crystal layer 392 in the image formation region 355. In this process, the counter substrate 391 is heated from the −Y side, but is cooled from the +Y side and the −Z side by the cooling air W from the cooling fan 481, and is efficiently cooled as a whole toward the +Z-side end through the heat exchange and heat dissipation. Since the element substrate 393 and the counter substrate 491 are cooled, an excessive rise in temperature and deterioration of the performance of the liquid crystal panel 371 are suppressed, so that the blue light LB is converted into the image light IB at improved efficiency.

The illumination margin in the blue light emitter 101 in the second embodiment is suppressed to the size of the counter substrate 491 in the Y direction, that is, the thickness of the counter substrate 491.

Although not shown, in the projector according to the second embodiment, a standalone dustproof glass plate is not disposed in the liquid crystal panel for the green light LG, and the −X-side plate surface of the counter substrate is in contact with the light exiting surface 162b of the light guiding member 162. The counter substrate of the liquid crystal panel for the green light LG has extensions extending toward the ±Y side and the ±Z side beyond the light exiting surface 162b when viewed along the X direction. The cooling fan 482 delivers cooling air to the counter substrate of the liquid crystal panel for the green light LG and the light guiding member 162.

In the projector according to the second embodiment, a standalone dustproof glass plate is not disposed in the liquid crystal panel for the red light LR, and the −Y-side plate surface of the counter substrate is in contact with the light exiting surface 163b of the light guiding member 163. The counter substrate of the liquid crystal panel for the red light LR has extensions extending toward the ±X side and the ±Z side beyond the light exiting surface 163b when viewed along the Y direction. The cooling fan 483 delivers cooling air to the counter substrate of the liquid crystal panel for the red light LR and the light guiding member 163.

The projector according to the second embodiment described above includes the light sources (first light source) 121, the light collector (first light collector) 141, the light guiding member (first light guiding member) 161, and the liquid crystal panel (first liquid crystal panel) 371. The liquid crystal panel 371 modulates the blue light LB output from the light guiding member 161 to generate the image light IB. In the projector according to the second embodiment, the light exiting surface 161b of the light guiding member 161 and a portion of the light incident side of the liquid crystal panel 371, on which the blue light LB is incident, (portion of light incident side) are in contact with each other. For example, the portion of the light incident side of the liquid crystal panel 371, on which the blue light LB is incident, is the portion of the +Y-side plate surface of the counter substrate 491 on which the blue light LB is incident and which is a region that coincides with the light exiting surface 161b of the light guiding member 161 and contains the center of the +Y-side plate surface of the counter substrate 491 when viewed along the Y direction.

In the projector according to the second embodiment, since the light exiting surface 161b of the light guiding member 161 and the portion of the +Y-side plate surface of the counter substrate 491 of the liquid crystal panel 371 are in contact with each other, leakage of the blue light LB in the Y direction and in the XZ plane to the space outside the light guiding member 161 and the liquid crystal panel 371 is suppressed. In the projector according to the second embodiment, the illumination margin with respect to each of the image formation regions 355, 356, and 357 is satisfactorily suppressed. Furthermore, since no polarizer plate is disposed at the light incident side of each of the liquid crystal panels 351, 352, and 353, there is no decrease caused by the polarizer plate in the light use efficiency at the light incident side of each of the liquid crystal panels 351, 352, and 353. Therefore, in the projector according to the second embodiment, the blue light LB output from the light guiding member 161 efficiently enters the liquid crystal panel 371, the green light LG output from the light guiding member 162 efficiently enters a liquid crystal panel 372, and the red light LR output from the light guiding member 163 efficiently enters a liquid crystal panel 373. The projector according to the second embodiment allows the blue light LB, the green light LG, and the red light LR each to be used at increased efficiency.

The projector according to the second embodiment can provide effects and advantages achieved by the configurations common to those of the projector 501 according to the first embodiment.

In the projector according to the second embodiment, the liquid crystal panel 371 has the image formation region 355, in which multiple pixels are arranged. The liquid crystal panel 371 includes the counter substrate (first substrate) 491, the liquid crystal layer 392, the element substrate (second substrate) 393, and the light-exiting-side polarizer plate (light-exiting-side dustproof member) 361. In the projector according to the second embodiment, the light exiting surface 161b of the light guiding member 161 is in contact with the counter substrate 491.

In the projector according to the second embodiment, the counter substrate 491, which is disposed at a position closest to the +Y side in the liquid crystal panel 351, has a portion that overlaps with the light exiting surface 161b of the light guiding member 161 when viewed along the Y direction in the XY plane, and the portion is in contact with the light exiting surface 161b. The projector according to the second embodiment allows the gap between the light exiting surface 161b of the light guiding member 161 and the light incident surface of the liquid crystal layer 392 of the liquid crystal panel 371 to be equal to the thickness of the counter substrate 491 in the Y direction. As a result, the leakage of the color light between the light guiding member 161 and the counter substrate 491 can be satisfactorily prevented, so that the illumination margin with respect to the image formation region 355 can be suppressed to a small region.

The projector according to the second embodiment further includes the cooling fan 481, which delivers the cooling air (air) W to the liquid crystal panel 371. In the projector according to the second embodiment, the planar size of the counter substrate 491 viewed along the optical axis AX1 of the blue light LB and the Y direction, that is, the size in the XY plane is greater than the planar size of each of the element substrate 393 and the light-exiting-side polarizer plate 361. The cooling fan 481 delivers the cooling air W to the counter substrate 491.

In the projector according to the second embodiment, the cooling air W is delivered from the cooling fan 481 to the extension of the counter substrate 491, which extends off the element substrate 393 and the light-exiting-side polarizer plate 361 when viewed along the Y direction. The cooling air W from the cooling fan 481 primarily directly cools the counter substrate 491, and indirectly cools the light guiding member 161, which is in contact with the counter substrate 491. The element substrate 393 is cooled in the same manner as in related art. As a result, deterioration of the performance of the liquid crystal panel 371 due to the radiation of the blue light LB is suppressed. The projector according to the second embodiment effectively suppresses deterioration of the performance of the liquid crystal panel 371, and allows long-term use of the liquid crystal panel 371.

In the projector according to the second embodiment, the cooling fan 481 delivers the cooling air W also to the light guiding member 161.

In the projector according to the second embodiment, the light guiding member 161 is cooled by part of the cooling air W from the cooling fan 481. The projector according to the second embodiment allows suppression of disturbance of the polarization direction of the blue light LB propagating through the interior of the light guiding member 161. The projector according to the second embodiment can receive heat from the counter substrate 491 of the liquid crystal panel 371 in contact with the light guiding member 161 and efficiently dissipate the heat via the light guiding member 161 having a surface area greater than that of the counter substrate 491.

### Variation of Second Embodiment

A variation of the second embodiment of the present disclosure will next be described. Although not shown, in the variation of the projector according to the second embodiment, an air layer is provided in the Y direction between the +Y-side plate surface of the counter substrate 491 of the liquid crystal panel 371 and the −Y-side end surface of the light guiding member 161 of the blue light emitter 101, that is, the light exiting surface 161b. The thickness of the air layer in the Y direction, that is, the separation distance between the light exiting surface 161b and the +Y-side plate surface of the counter substrate 491 is smaller than or equal to 3 μm, preferably smaller than or equal to 1 μm.

The variation of the projector according to the second embodiment includes a state in which the light exiting surface 161b and the portion (part) of the +Y-side plate surface of the counter substrate 491 that overlaps with the light exiting surface 161b when viewed at least along the Y direction have the same flatness and two types of minute unevenness in the XZ plane similar to each other and the two surfaces are entirely in contact with each other. The variation of the projector according to the second embodiment also includes a state in which one of the light exiting surface 161b and the portion of the +Y-side plate surface of the counter substrate 491 has flatness different from that of the other and minute unevenness in the XZ plane different from that of the other and the separation distance in the Y direction between the light exiting surface 161b and the portion of the +Y-side plate surface of the counter substrate 491 varies. The separation distance in this case is, for example, greater than 0 μm but smaller than or equal to 3 μm, and preferably smaller than or equal to 1 μm.

The variation of the projector according to the second embodiment includes the light sources (first light source) 121, the light collector (first light collector) 141, the light guiding member (first light guiding member) 161, and the liquid crystal panel (first liquid crystal panel) 371. In the variation of the projector according to the second embodiment, the air layer having the thickness of 3 μm or smaller is provided between the light exiting surface 161b of the light guiding member 161 and a portion of the light incident side of the liquid crystal panel 371, on which the blue light LB is incident, (portion of light incident side).

In the variation of the projector according to the second embodiment, since the thickness of the air layer between the light exiting surface 161b of the light guiding member 161 and the portion of the +Y-side plate surface of the counter substrate 491 of the liquid crystal panel 371 is 3 μm or smaller, leakage of the blue light LB in the Y direction and in the XZ plane to the space outside the light guiding member 161 and the liquid crystal panel 371 is suppressed in substantially the same manner as the state in which the light exiting surface 161b and the portion of the +Y-side plate surface of the counter substrate 491 are in contact with each other. When the image light IB is generated, the liquid crystal panel 371 generates heat, which heats the counter substrate 491. Since the thickness of the air layer between the light exiting surface 161b and the portion of the +Y-side plate surface of the counter substrate 491 is suppressed to 3 μm or smaller, the heat exchange and heat dissipation between the counter substrate 491 and the light guiding member 161 are performed in substantially the same manner as the state in which the light exiting surface 161b and the portion of the +Y-side plate surface of the counter substrate 491 are in contact with each other, and the counter substrate 491 is efficiently cooled as a whole including the −Z side end portion. Furthermore, in the variation of the projector according to the second embodiment, the illumination margin with respect to each of the image formation regions 355, 356, and 357 is satisfactorily suppressed. Moreover, since no polarizer plate is disposed at the light incident side of each of the liquid crystal panels 371, 352, and 353, there is no decrease caused by the polarizer plate in the light use efficiency at the light incident side of each of the liquid crystal panels 371, 352, and 353. Therefore, in the variation of the projector according to the second embodiment, the blue light LB output from the light guiding member 161 efficiently enters the liquid crystal panel 371, the green light LG output from the light guiding member 162 efficiently enters the liquid crystal panel 352, and the red light LR output from the light guiding member 163 efficiently enters the liquid crystal panel 353. The variation of the projector according to the second embodiment allows the blue light LB, the green light LG, and the red light LR each to be used at increased efficiency.

The variation of the projector according to the second embodiment can provide effects and advantages achieved by the configurations common to those of the projector according to the second embodiment.

Preferable embodiments of the present disclosure have been described above in detail. The present disclosure is, however, not limited to a specific embodiment, and a variety of modifications and changes can be made to the embodiments within the scope of the substance of the present disclosure described in the claims.

For example, in the embodiments described above, a three-plate projector using three types of color light, the blue light LB, the green light LG, and the red light LR, is presented by way of example, and a projector according to an aspect of the present disclosure may, for example, be a single-plate projector using one type of linearly polarized color light, or may be a projector using four or more types of linearly polarized color light that can be combined with one another by multiple light combining members.

### Summary of Present Disclosure

The present disclosure will be summarized below as additional remarks.

(Additional remark 1) A projector including: a first light source configured to output linearly polarized first light; a first light collector configured to collect the first light output from the first light source; a first light guiding member configured to guide the first light output from the first light collector; and a first liquid crystal panel configured to modulate the first light output from the first light guiding member, wherein the first light guiding member has a first light incident surface on which the first light output from the first light collector is incident, a first light exiting surface via which the first light exits toward the first liquid crystal panel, and a first inclining section inclining with respect to a first optical axis of the first light guiding member, a cross-sectional area of the first inclining section increasing as the first light guiding member extending in a direction in which the first light is guided, the first light exiting surface of the first light guiding member and a light-incident-side portion of the first liquid crystal panel are in contact with each other, or an air layer having a dimension of 3 μm or smaller is provided between the first light exiting surface and the light-incident-side portion.

The configuration described in the additional remark 1 suppresses leakage of the first light output from the first light source through the gap between the first light guiding member and the first liquid crystal panel, suppresses the illumination margin with respect to an image formation region of the first liquid crystal panel, and eliminates a need to consider loss of the first light due to a polarizer plate at the light incident side of the first liquid crystal panel, so that the first light can be used at increased efficiency.

(Additional remark 2) The projector according to the additional remark 1, wherein the linearly polarized first light output from the first light source enters the first liquid crystal panel with no change in a polarization direction of the first light between the first light source and the first liquid crystal panel.

The configuration described in the additional remark 2, which suppresses variation in the polarization direction of the first light along the path before the first light enters the first liquid crystal panel and rotation of the polarization direction around the first optical axis in the plane perpendicular to the first optical axis, can minimize loss of the amount of the first light that enters the first liquid crystal panel.

(Additional remark 3) The projector according to the additional remark 1 or 2, wherein a cross section of the first light guiding member that is perpendicular to the first optical axis thereof has a quadrangular shape, the first light exiting surface has a rectangular shape, and a polarization direction of the linearly polarized first light is a direction along one of a direction of long sides of the rectangular shape and a direction of short sides of the rectangular shape.

The configuration described in the additional remark 3, in which when the first light enters the first light guiding member, the polarization direction of the first light is along a preferable direction as the polarization direction of the first light to be incident on multiple pixels of the first liquid crystal panel, can minimize loss of the amount of the first light that caused in the path along which the first light is guided by the first light guiding member and enters the first liquid crystal panel, readily control the first light at each of the pixels of the first liquid crystal panel, and generate image light.

(Additional remark 4) The projector according to any one of the additional remarks 1 to 3, wherein the first liquid crystal panel has an image formation region where multiple pixels are arranged, the first liquid crystal panel includes a first substrate, a second substrate facing the first substrate with a liquid crystal layer interposed therebetween, a light-incident-side dustproof member disposed at a light incident side of the first substrate, and a light-exiting-side dustproof member disposed at a light exiting side of the second substrate, and the first light exiting surface is in contact with the light-incident-side dustproof member, or the air layer is provided between the first light exiting surface and the light-incident-side dustproof member.

The configuration described in the additional remark 4 can suppress the separation distance between the first light guiding member and the liquid crystal layer of the first liquid crystal panel to be equal to the sum of the thickness of the light-incident-side dustproof member and the thickness of the first substrate, preferably prevent leakage of the first light through the gap between the first light guiding member and the light-incident-side dustproof member, and suppress the illumination margin with respect to the image formation region of the first liquid crystal panel to a small region to use the first light at increased efficiency.

(Additional remark 5) The projector according to the additional remark 4, further including a cooling fan configured to deliver air to the first liquid crystal panel, wherein a planar size of the light-incident-side dustproof member viewed along the first optical axis is greater than a planar size of each of the first substrate, the second substrate, and the light-exiting-side dustproof member, and the cooling fan delivers the air to the light-incident-side dustproof member.

The configuration described in the additional remark 5, in which the light-incident-side dustproof member of the first liquid crystal panel to which the air from the cooling fan is supplied is cooled, and an excessive rise in temperature and failure in the operation of the first liquid crystal panel due to the radiation of the first light are prevented, can effectively suppress deterioration of the performance of the first liquid crystal panel and allows long-term use of the first liquid crystal panel.

(Additional remark 6) The projector according to the additional remark 5, wherein the cooling fan delivers the air also to the first light guiding member.

The configuration described in the additional remark 6, in which the first light guiding member having a surface area greater than that of the light-incident-side dustproof member of the first liquid crystal panel is cooled by part of the air supplied from the cooling fan, can efficiently dissipate heat transferred from the first liquid crystal panel.

(Additional remark 7) The projector according to any one of the additional remarks 1 to 3, wherein the first liquid crystal panel has an image formation region where multiple pixels are arranged, the first liquid crystal panel includes a first substrate, a second substrate facing the first substrate with a liquid crystal layer interposed therebetween, and a light-exiting-side dustproof member disposed at a light exiting side of the second substrate, and the first light exiting surface is in contact with the first substrate, or the air layer is provided between the first light exiting surface and the first substrate.

The configuration described in the additional remark 7 can suppress the separation distance between the first light guiding member and the liquid crystal layer of the first liquid crystal panel to be equal to the thickness of the first substrate, preferably prevent leakage of the first light through the gap between the first light guiding member and the light-incident-side dustproof member, and suppress the illumination margin with respect to the image formation region of the first liquid crystal panel to a small region to use the first light at increased efficiency.

(Additional remark 8) The projector according to the additional remark 7, further including a cooling fan configured to deliver air to the first liquid crystal panel, wherein a planar size of the first substrate viewed along the first optical axis is greater than a planar size of each of the second substrate and the light-exiting-side dustproof member, and the cooling fan delivers the air to the first substrate.

The configuration described in the additional remark 8, in which the first substrate of the first liquid crystal panel to which the air from the cooling fan is supplied is cooled, and an excessive rise in temperature and failure in the operation of the first liquid crystal panel due to the radiation of the first light are prevented, can effectively suppress deterioration of the performance of the first liquid crystal panel and allows long-term use of the first liquid crystal panel.

(Additional remark 9) The projector according to the additional remark 8, wherein the cooling fan delivers the air also to the first light guiding member.

The configuration described in the additional remark 9, in which the first light guiding member having a surface area greater than that of the first substrate of the first liquid crystal panel is cooled by part of the air supplied from the cooling fan, can efficiently dissipate heat transferred from the first liquid crystal panel.

(Additional remark 10) The projector according to any one of the additional remarks 1 to 9, further including a first diffuser including a first diffuser substrate configured to diffusively output the first light incident thereon and a first driver configured to rotate the first diffuser substrate, wherein the first diffuser is disposed between the first light collector and the first light guiding member.

The configuration described in the additional remark 10, in which the illuminance distribution of the first light that enters the first light guiding member is diffused by the diffuser substrate of the first diffuser, can increase the uniformity of the illuminance distribution of the first light output from the first light guiding member.

(Additional remark 11) The projector according to any one of the additional remarks 1 to 10, further including: a second light source configured to output linearly polarized second light that belongs to a second wavelength band different from a first wavelength band to which the first light belongs; a second light collector configured to collect the second light output from the second light source; a second light guiding member configured to guide the second light output from the second light collector; a second liquid crystal panel configured to modulate the second light output from the second light guiding member; and a light combining member configured to combine the first light and the second light with each other and output combined light, wherein the second light guiding member has a second light incident surface on which the second light output from the second light collector is incident, a second light exiting surface via which the second light exits toward the second liquid crystal panel, and a second inclining section inclining with respect to a second optical axis of the second light guiding member, a cross-sectional area of the second inclining section increasing as the second light guiding member extending in a direction in which the second light is guided, and the second light exiting surface of the second light guiding member and a light-incident-side portion of the second liquid crystal panel are in contact with each other, or an air layer having a dimension of 3 μm or smaller is provided between the second light exiting surface and the light-incident-side portion.

The configuration described in the additional remark 11 allows the first light output from the first light source 121 and the second light output from the second light source to be used at increased efficiency to increase the brightness of the color light containing the first light and the second light projected from the projector.

What is claimed is:

1. A projector comprising:
a first light source configured to output linearly polarized first light;
a first light collector configured to collect the first light output from the first light source;
a first light guiding member configured to guide the first light output from the first light collector; and
a first liquid crystal panel configured to modulate the first light output from the first light guiding member,
wherein the first light guiding member has
a first light incident surface on which the first light output from the first light collector is incident,
a first light exiting surface via which the first light exits toward the first liquid crystal panel, and
a first inclining section inclining with respect to a first optical axis of the first light guiding member, a cross-sectional area of the first inclining section increasing as the first light guiding member extending in a direction in which the first light is guided,
the first light exiting surface of the first light guiding member and a light-incident-side portion of the first liquid crystal panel are in contact with each other, or an air layer having a dimension of 3 μm or smaller is provided between the first light exiting surface and the light-incident-side portion.

2. The projector according to claim 1, wherein
the linearly polarized first light output from the first light source enters the first liquid crystal panel with no change in a polarization direction of the first light between the first light source and the first liquid crystal panel.

3. The projector according to claim 1, wherein
a cross section of the first light guiding member that is perpendicular to the first optical axis thereof has a quadrangular shape,
the first light exiting surface has a rectangular shape, and
a polarization direction of the linearly polarized first light is a direction along one of a direction of long sides of the rectangular shape and a direction of short sides of the rectangular shape.

4. The projector according to claim 1, wherein
the first liquid crystal panel has an image formation region where multiple pixels are arranged,
the first liquid crystal panel includes
a first substrate,
a second substrate facing the first substrate with a liquid crystal layer interposed therebetween,
a light-incident-side dustproof member disposed at a light incident side of the first substrate, and
a light-exiting-side dustproof member disposed at a light exiting side of the second substrate, and
the first light exiting surface is in contact with the light-incident-side dustproof member, or the air layer is provided between the first light exiting surface and the light-incident-side dustproof member.

5. The projector according to claim 4, further comprising
a cooling fan configured to deliver air to the first liquid crystal panel,
wherein a planar size of the light-incident-side dustproof member viewed along the first optical axis is greater than a planar size of each of the first substrate, the second substrate, and the light-exiting-side dustproof member, and
the cooling fan delivers the air to the light-incident-side dustproof member.

6. The projector according to claim 5, wherein
the cooling fan delivers the air also to the first light guiding member.

7. The projector according to claim 1, wherein
the first liquid crystal panel has an image formation region where multiple pixels are arranged,
the first liquid crystal panel includes
a first substrate,
a second substrate facing the first substrate with a liquid crystal layer interposed therebetween, and
a light-exiting-side dustproof member disposed at a light exiting side of the second substrate, and
the first light exiting surface is in contact with the first substrate, or the air layer is provided between the first light exiting surface and the first substrate.

8. The projector according to claim 7, further comprising
a cooling fan configured to deliver air to the first liquid crystal panel,
wherein a planar size of the first substrate viewed along the first optical axis is greater than a planar size of each of the second substrate and the light-exiting-side dustproof member, and
the cooling fan delivers the air to the first substrate.

9. The projector according to claim 8, wherein
the cooling fan delivers the air also to the first light guiding member.

10. The projector according to claim 1, further comprising
a first diffuser including a first diffuser substrate configured to diffusively output the first light incident thereon and a first driver configured to rotate the first diffuser substrate,
wherein the first diffuser is disposed between the first light collector and the first light guiding member.

11. The projector according to claim 1, further comprising:
a second light source configured to output linearly polarized second light that belongs to a second wavelength band different from a first wavelength band to which the first light belongs;
a second light collector configured to collect the second light output from the second light source;
a second light guiding member configured to guide the second light output from the second light collector;
a second liquid crystal panel configured to modulate the second light output from the second light guiding member; and
a light combining member configured to combine the first light and the second light with each other and output combined light,
wherein the second light guiding member has
a second light incident surface on which the second light output from the second light collector is incident,
a second light exiting surface via which the second light exits toward the second liquid crystal panel, and
a second inclining section inclining with respect to a second optical axis of the second light guiding member, a cross-sectional area of the second inclining section increasing as the second light guiding member extending in a direction in which the second light is guided, and
the second light exiting surface of the second light guiding member and a light-incident-side portion of the second liquid crystal panel are in contact with each other, or an air layer having a dimension of 3 μm or smaller is provided between the second light exiting surface and the light-incident-side portion.
